(19) United States
(12) Patent Application Publication
(10) Pub. No.: US 2025/0166356 A1
(43) Pub. Date: May 22, 2025

(54) LEARNING DEVICE, LEARNING METHOD, AND RECORDING MEDIUM

(71) Applicants: NEC Corporation, Tokyo (JP); UNIVERSITY OF TSUKUBA, Tsukuba-shi, Ibaraki (JP)

(72) Inventors: Kazuya KAKIZAKI, Tokyo (JP); Kazuto FUKUCHI, Tsukuba-shi (JP); Jun SAKUMA, Tsukuba-shi (JP)

(73) Assignees: NEC Corporation, Tokyo (JP); UNIVERSITY OF TSUKUBA, Tsukuba-shi, Ibaraki (JP)

(21) Appl. No.: 18/841,744

(22) PCT Filed: Mar. 4, 2022
(86) PCT No.: PCT/JP2022/009574

§ 371 Date: Aug. 27, 2024

(51) Int. Cl. G06V 10/77; G06F 16/583; G06V 10/778

(52) U.S. Cl. CPC G06V 10/7715; G06F 16/583; G06V 10/778

(57) ABSTRACT

A learning device causes a feature amount extractor to be trained such that the upper limit and the lower limit of a distance, obtained in a case where the feature amount extractor is used, in a feature space between images become close to the distance.

### TECHNICAL FIELD

This invention relates to a learning device, a learning method, and a recording medium.

### BACKGROUND ART

Adversarial training (AX) has been proposed as a countermeasure against attacks using adversarial examples. Adversarial training is the practice of learning by including adversarial examples in the training data when learning a feature amount extraction model. By using a feature amount extraction model that has undergone adversarial training, it is expected that the output results are less likely to be affected by the input of adversarial examples.

For example, Non-Patent Document 1 shows experimentally that adversarial training is effective against attacks on content-based image retrieval using adversarial examples.

### PRIOR ART DOCUMENTS

### Non Patent Document

Non Patent Document 1: Mo Zhou, et al. “Adversarial Ranking Attack and Defense,” The 2020 European Conference on Computer Vision (ECCV 2020), 2020.

### SUMMARY OF THE INVENTION

### Problems to be Solved by the Invention

Non-patent Document 1 describes adversary training that depends on the attack method when the attack method is known, such as how the adversarial example is generated.

On the other hand, there may be unknown attack methods against content-based image retrieval using adversarial examples, which should be addressed. It should be possible to verify the degree of impact on search results given an adversarial example and to ascertain the impact when the attack method is unknown.

An example of an object of the present invention is to provide a learning device, a learning method, and a recording medium that can solve the above-mentioned problems.

### Means for Solving the Problem

According to the first example aspect of the present invention, a learning device is provided with a learning means that performs learning of a feature amount extractor f such that the upper limit and the lower limit of a distance, obtained when the feature amount extractor is used, in a feature space between images become close to the distance.

According to the second example aspect of the invention, a learning method includes a step of learning a feature extractor f such that the upper limit and the lower limit of a distance, obtained when the feature amount extractor is used, in a feature space between images become close to the distance.

According to the third example aspect of the invention, a recording medium is one that records a program for causing a computer to execute a step of learning a feature extractor f such that the upper limit and the lower limit of a distance, obtained when the feature amount extractor is used, in a feature space between images become close to the distance.

### Effect of Inventions

According to the above learning device, learning method, and recording medium, it is possible to verify the degree of influence on search results in content-based image retrieval when an adversarial example with adversarial perturbation is applied.

### BRIEF DESCRIPTION OF THE DRAWINGS

FIG. 1 is a schematic block diagram showing an example of the functional configuration of a content-based image retrieval device 900.

FIG. 2 is a drawing showing the range of image x+δ, where noise δ with a radius of ε or less is applied to image x in the infinity norm L_{∞}.

FIG. 3 is a drawing showing a specific example of (α, ß)-robustness verification.

FIG. 4 is a schematic block diagram showing an example of the functional configuration of the robustness verification device according to the first example embodiment.

FIG. 5 is a flowchart showing an example of the processing procedure of the robustness verification device according to the first example embodiment.

FIG. 6 is a schematic block diagram showing an example of the functional configuration of the robustness verification device according to the second example embodiment.

FIG. 7 is a flowchart showing an example of the processing procedure of the robustness verification device according to the second example embodiment.

FIG. 8 is a diagram showing minimization of the TripletLoss loss function.

FIG. 9 is a schematic block diagram showing an example of the functional configuration of the learning device according to the third example embodiment.

FIG. 10 is a flowchart showing an example of the processing procedure of the learning device according to the third example embodiment.

FIG. 11 is a schematic block diagram showing an example of the functional configuration of the learning device according to the fourth example embodiment.

FIG. 12 is a flowchart showing an example of the processing procedure of the learning device according to the fourth example embodiment.

FIG. 13 is a schematic block diagram showing an example of the functional configuration of the learning device according to the fifth example embodiment.

FIG. 14 is a flowchart showing an example of the processing procedure of the learning device according to the fifth example embodiment.

FIG. 15 is a schematic block diagram showing an example of the functional configuration of the learning device according to the sixth example embodiment.

FIG. 16 is a flowchart showing an example of the processing procedure of the learning device according to the sixth example embodiment.

FIG. 17 is a schematic block diagram showing an example of the functional configuration of the learning device according to the seventh example embodiment.

FIG. 18 is a flowchart showing an example of the processing procedure of the learning device according to the seventh example embodiment.

FIG. 19 is a schematic block diagram showing the configuration of a computer according to at least one example embodiment.

### EXAMPLE EMBODIMENT

The following describes example embodiments of the present invention, but these example embodiments are not intended to limit the invention as claimed. Not all of the combinations of features described in the example embodiments are essential to the solution of the invention.

### [Content-Based Image Retrieval Device 900]

First, an example of a content-based image retrieval device 900 that is subject to robustness verification by a robustness verification device 100 (200) shall be described.

In the real world, content-based image retrieval (CBIR) is used in medical image retrieval systems, similar product retrieval systems, facial recognition systems, and others. Content-based image retrieval is a system that, given an input image q∈χ as a search query, finds an image cᵢ∈C that is highly similar to q from a set of candidate images C={cᵢ∈χ}(i=1 to N). Here, χ represents the input space of images.

In content-based image retrieval, a feature extraction model f is used, which is learned by a machine learning model such as Deep Metric Learning (DML), for example. For example, a feature extraction amount model f is a function f·χ→*Rⁿ from the input space of images to the n-dimensional vector space of real numbers representing feature amounts. Deep Metric Learning learns a feature amount extraction function f so that features can be computed such that the distance between images with high similarity is close and the distance between images with low similarity is far.

Content-based image retrieval outputs results based on the Euclidean distance dist(f(q), f(c)) of features quantities between the input image q and any candidate image c ∈ C. For example, content-based image retrieval outputs the top k candidate images c ∈ C with the smallest distance from the input image q as similar images of q.

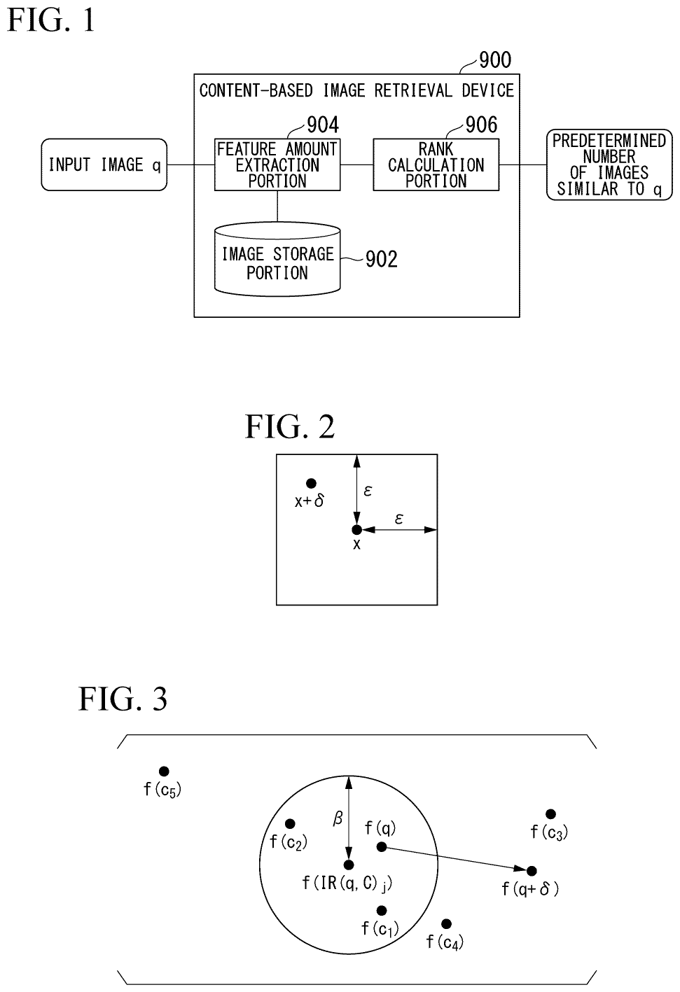

FIG. 1 is a schematic block diagram showing an example configuration of the content-based image retrieval device 900.

When an input image q∈χ is given as a search query, the content-based image retrieval device 900 retrieves and outputs images similar to q from a set of candidate images C={cᵢEχ}(i=1 to N). Here, χ represents the input space of images. The content-based image retrieval device 900 includes an image storage portion 902, a feature amount extraction portion 904, and a rank calculation portion 906.

The image storage portion 902 stores a group of candidate images (hereinafter referred to as the candidate image group). C={cᵢ∈χ}(i=1 to N) is stored. Each c₁ is called a candidate image. Note that the candidate image group C may be input to the content-based image retrieval device 900 without being stored in a storage portion.

The feature amount extraction portion 904 extracts the feature amount of the input image q and the image cᵢ∈C (i=1 to N) obtained from the image storage portion 902 using the feature amount extractor f. The feature amount extractor f is, for example, a function f·χ→Rⁿ from the image space of images χ to an n-dimensional vector space of a real number representing the feature amount (hereinbelow referred to as the feature space). This feature amount extractor f is a function that has been pre-trained using a deep learning model such as deep distance learning, for example. Deep Metric Learning learns the feature amount extractor f so that feature amounts can be computed such that the distance between images with high similarity is close and the distance between images with low similarity is far.

The rank calculation portion 906 calculates the Euclidean distance dist(f(q), f(cᵢ) between the extracted feature amount f(q) and each f(cᵢ) (i=1 to N). Then, the rank calculation portion 906 outputs the predetermined number of images cᵢ in order of decreasing distance as images similar to the input image q. The image that is j-th similar (j-th smallest distance) to the input image q is described as IR(q, C)ⱼ. IR stands for Image Retrieval.

The content-based image retrieval device that the robustness verification device 100 (200) targets for robustness verification is not limited to the content-based image retrieval device 900, as long as the feature amount extractor f can be used to rank the candidate image groups C with respect to the input image q.

The robustness verification device 100 (200) has as part of its input the input image q, the candidate image group C, and the feature amount extractor f, which are the parameters of the content-based image retrieval device 900.

### [Noise]

Next, an explanation shall be given about the noise, which is a small adversarial perturbation intentionally added to images, as assumed by the robustness verification device 100 (200).

An Adversarial Example (AX) is known to be a serious problem for the security of machine learning models. An adversarial example is data that is created by intentionally adding minute perturbations that cause machine learning models, such as feature amount extraction models, to make incorrect decisions. Perturbations added by an adversarial example are referred to as adversarial perturbations. Machine learning models may output different classes or values when inputted with adversarial examples compared to data without adversarial perturbations.

Attacks by adversarial examples are also possible against content-based image retrieval using feature extraction models. In this case, the adversarial perturbation is noise, etc. added to the image. Two potential threats to content-based image retrieval by adversarial examples are the query attack and the candidate attack. A query attack is one that manipulates the output of content-based image search by entering an adversarial example as an input image, which is the search query. A candidate attack is one that manipulates the output of content-based image retrieval by inputting adversarial examples as candidate images. Both attacks are accomplished by manipulating the output of the feature amount extraction model with adversarial examples.

An example of an attack using an adversarial example would be to give priority to recommending one's own products in a similar product search system used for online sales using content-based image search. Another example would be impersonation of another person's face in a face recognition system using content-based image retrieval.

The robustness verification device 100 (200) verifies that, given the input space of images X, the ranking of the input image q and the j-th nearest image IR(q, C)ⱼ in the candidate image group C varies only at most α, even if the image x∈χ is given noise δ∈χ with a radius of ∈ or less in the infinity norm L_{∞}. That is, the robustness verification device 100 (200) verifies that the rank of image IR(q, C)ⱼ varies only at most α even if image x is a noise-laden image x+δ for ∀δ∈{δ∈χ|∥∞≤ε}. The image x to which noise is added is the input image q in the case of the robustness verification device 100 and any candidate image cᵢ∈C in the case of the robustness verification device 200.

FIG. 2 is a diagram showing the range of image x+δ, where noise δ with a radius of ε or less in the infinity norm L_{∞} is applied to image x. As shown in FIG. 2, for the infinity norm, this range is a hypersphere with radius e centered at x. The image x+δ is an element in this hypersphere. The infinity norm L_{∞} is an example, and the norm is not limited thereto.

### First Example Embodiment

Next, the first example embodiment of the present invention shall be described. The first example embodiment is a robustness verification device 100 that verifies the robustness of a content-based image retrieval device 900 against query attacks.

Let q be the input image that is the query of the content-based image retrieval device 900, and q+δ be the input image with noise δ of magnitude e or less. Let IR(q, C)ⱼ be the j-th similar image to q that the content-based image retrieval device 900 retrieves from the candidate image group C={cᵢ∈χ}(i=1 to N) when the input image q is input.

In this case, the robustness verification device 100 verifies whether the ranking of IR(q, C)ⱼ does not change so much when the input image q+δ is input to the content-based image retrieval device 900. Specifically, the robustness verification device 100 verifies whether the ranking of IR(q, C)ⱼ changes only by at most α in the target image group C_{ß} with low similarity to IR(q, C)ⱼ, even if the input image q+δ is input to the content-based image retrieval device 900.

[(α, ß)-robustness verification against query attack]

First, (α, ß)-robustness verification, which is a fundamental concept when verifying robustness with the robustness verification device 100, shall be explained.

The (α, ß)-robustness verification against query attacks is defined as follows.

Let a be a natural number greater than or equal to 0 and let ß be a real number greater than or equal to 0. At this time, with respect to

$$\begin{matrix}[ Expression 1 ] & \\ ∀ δ ∈ \{ δ \vert δ ∈ 𝒳 , {‖ δ ‖}_{p} \leq ϵ \} & ( 1 )\end{matrix}$$

IR(q, C)ⱼ being (α, ß)-robustly verified means that

$$\begin{matrix}[ Expression 2 ] & \\ Rank ( q , {IR ( q , C )}_{j} {C}_{β} ) - α \leq Rank ( q + δ , {IR ( q , C )}_{j} , {C}_{β} ) \leq Rank ( q , {IR ( q , C )}_{j} {C}_{β} ) + α & ( 2 )\end{matrix}$$

holds true. Here,

$$\begin{matrix}[ Expression 3 ] & \\ {C}_{β} = \{ {IR ( q , C )}_{j} \} ⋃ \{ c \vert c ∈ C , β \leq {‖ f ( c ) - f ( {IR ( q , C )}_{j} ) ‖}_{q} \} & ( 3 )\end{matrix}$$

is.

Expression (1) represents the range of noise δ imparted to the input image. X represents the input space of images. “δ∈χ” denotes that δ is also an element of the input space of images. “∥δ∥ₚ” denotes the infinity norm L_{∞} of δ. “∥δ∥ₚ≤ε” indicates that the magnitude of δ is less than or equal to e when the infinity norm L_{∞} of δ is taken. This is illustrated in FIG. 2. The p-norm is not limited to the infinity norm, but can be 1, 2, or p norms.

Expression (3) expresses the set of images C_{ß} (hereafter referred to as the target image group) subject to the robustness verification in Expression (2). “{IR(q, C)ⱼ}” indicates that IR(q, C)ⱼ(the candidate image j-th similar to q that the content-based image retrieval device 900 retrieves from the candidate image group C when input image q is input) is included in Cß.

For “{c|c∈C, ß≤∥f(c)−f(IR(q, C)ᵢ)∥_{q}}”, first, “c∈C” represents the condition that c is an element of the candidate image group C. “f(c)” represents the feature amount extracted by the feature amount extractor f for image c. This feature amount extractor f is the feature amount extractor of the content-based image retrieval device 900. “{ß<∥ f(c)−f(IR(q, C)ⱼ)∥_{q}}” represents the condition that the magnitude in the q-norm of the difference between the feature amount of image IR(q, C)ⱼ and the feature amount of image c is greater than or equal to ß. That is, such an image c is included in C_{ß}. ß is a parameter that determines the candidate images considered for variation in ranking. B represents that variation in ranking with images similar to IR(q, C)ⱼ is acceptable, by not including images with a distance difference less than ß in Cß. The larger the value of ß, the easier it is to achieve (α, ß)-robustness verification. Note that the q-norm can be any of 1, 2, p, or infinity norms.

Expression (2) represents the specific conditions for (α, ß)-robustness verification. Rank (q, c, C) represents the rank of image c in the candidate image group C with respect to similarity using the feature amount extractor f when the input image is q. Therefore, “Rank (q+δ, IR(q, C)ⱼ, C_{ß})” represents the rank of image IR(q, C)ⱼ in the target image group C_{ß} calculated by Expression (3), with q+δ being the input image. “Rank (q, IR(q, C)ⱼ, C_{ß})” represents the rank of image IR(q, C)ⱼ in the target image group CB calculated by Expression (3), where q is the input image. Therefore, Expression (2) expresses the condition that the rank of image IR(q, C)ⱼ in the target image group CB calculated by Expression (3) when the input image is q+δ varies only at most α from the rank of image IR(q, C)ⱼ when the input image is q. α is a parameter indicating the amount of variation in rank that is acceptable, i.e., that a ranking variation of at most α is permissible. The larger a is, the easier it is to verify (α, ß)-robustness.

FIG. 3 shows a specific example of (α, ß)-robustness verification. (α, ß)-robustness verification verifies whether the rank of IR(q, C)ⱼ varies only at most α in the target image group C_{ß} with low similarity to IR(q, C)ⱼ when noise δ of magnitude ε or less is added to the input image q.

FIG. 3 shows an example of a feature space with the feature amount extractor f. The circle shown in FIG. 3 has radius ß, with the center thereof being the point f(IR(q, C)ⱼ), which represents the feature amount by the feature amount extractor f of the image IR(q, C)ⱼ. f(q) and f(q+δ) are points representing the feature amounts by the feature amount extractor f of the input image q and the input image q+δ with noise δ, respectively. f(c₁), f(c₂), f(c₃), f(c₄) and f(c₅) are points representing the feature amounts by the feature amount extractor f of images c₁, c₂, c₃, c₄ and c₅ in the candidate image group C, respectively. The distance between the points represented by the feature amounts is the distance in the plane shown in FIG. 3.

As shown in FIG. 3, taking the parameter ß to account for the change in ranking, the images that satisfy ß≤∥f(c)−f(IR(q, C)ⱼ)∥_{q} in Expression (3) are c₃, c₄ and c₅ outside the circle. Therefore, C_{ß}={IR(q, C)ⱼ, c₃, c₄, c₅}.

Since the ranking by the content-based image retrieval device 900 using the input image q before noise assignment is in order of proximity to f(q) in the images included in C_{ß},
1st: IR(q, C)ⱼ
2nd: c₄
3rd: c₃
4th: C₅.

On the other hand, since the ranking by the content-based image retrieval device 900 using the input image q+δ after the noise δ is applied is in order of proximity to f(q+δ) in the images included in C_{ß}, the images are ranked in the order of:
1st: C₃
2nd: c₄
3rd: IR(q, C)ⱼ
4th: C₅.

Thus, in Expression (2), since Rank(q+δ, IR(q, C)ⱼ, C_{ß})=3, and Rank(q, IR(q, C)ⱼ, C_{ß})=1, Expression (2) is 1−α≤3≤1+α. Therefore, if α≥2, IR(q, C)ⱼ is (α, ß)-robustness verified, and if α=0 or 1, IR(q, C)ⱼ is not (α, ß)-robustness verified.

### [Robustness Verification Device 100]

The robustness verification device 100 performs the (α, ß)-robustness verification described above, but accurate computation of (α, ß)-robustness verification is difficult due to computational complexity issues. In other words, it is difficult for the robustness verification device 100 to verify Expression (2) for any δ that satisfies (1).

Therefore, the robustness verification device 100, with respect to

$$\begin{matrix}[ Expression 4 ] & \\ ∀ δ ∈ \{ δ \vert δ ∈ 𝒳 , {‖ δ ‖}_{p} \leq ϵ \} & ( 4 )\end{matrix}$$

utilizes the ability to calculate the upper and lower limits of d(f(q+δ), f(c)) with minimal computational effort. Here, q is the input image while c is an element of the target image group C.

In other words, the robustness verification device 100 calculates the lower and upper limits that satisfy

$$\begin{matrix}[ Expression 5 ] & \\ \underline{{d}_{q}} ( f ( q ) , f ( c ) ) \leq d ( f ( q + δ ) , f ( c ) ) \leq \overline{{d}_{q}} ( f ( q ) , f ( c ) ) & ( 5 )\end{matrix}$$

Here, “d(f(q+δ), f(c))” represents the Euclidean distance d(f(q+δ), f(c)) between the feature amount f(q+δ) of the input image q with noise δ and the feature amount f(c) of image c. “⁻d_{q}(f(q), f(c))” is the upper limit of d(f(q+δ), f(c)) for any δ satisfying Expression (4). The q in “d_{q}” indicates that noise has been added to q. “_d_{q}(f(q), f(c))” is the lower limit of d(f(q+δ), f(c)) for any δ satisfying Expression (4). The q in “_d_{q}” indicates that noise has been added to q.

The robustness verification device 100 performs calculations using, for example, the well-known technique Interval Bound Propagation (IBP), described in the following non-patent document. IBP is a method for computing the upper and lower limits of each element i of the feature amount f(q+δ) by sequentially computing the upper and lower limits of each element of the intermediate layer representation in each layer when an image q+δ with noise δ added is input for noise δ∈{δ|δ∥∞≤ε}with a magnitude in the infinity norm equal to or less than e. Here, i represents the i-th element (1≤i≤n) of the feature amount, assuming that the feature amount is an n-dimensional vector.

### Non Patent Document

Sven Gowal, and 8 others, “On the Effectiveness of Interval Bound Propagation for Training Verifiably Robust Models,” The 2019 International Conference on Computer Vision (ICCV 2019), 2019.

The robustness verification device 100 uses IBP to calculate the upper limit ⁻f(q)ᵢ and lower limit _f(q)ᵢ of f(q+δ)ᵢ, where i is the i-th element of the n-dimensional vector. The robustness verification device 100, using the upper limit and lower limit, then calculates the upper limit ⁻d_{q}(f(q), f(c)) and lower limit _d_{q}(f(q), f(c)) of d(f(q+δ) with Expressions (6) and (7), respectively.

$$\begin{matrix}[ Expression 6 ] & \\ \overline{{d}_{q}} ( f ( q ) , f ( c ) ) = {( {\sum }_{i} {max ( {\vert {\overline{f} ( q )}_{i} - {f ( c )}_{i} \vert}_{1} , {\vert {f ( c )}_{i} - {\underline{f} ( q )}_{i} \vert}_{1} )}^{2} )}^{\frac{1}{2}} & ( 6 )\end{matrix}$$

$$\begin{matrix}[ Expression 7 ] & \\ \underline{{d}_{q}} ( f ( q ) , f ( c ) ) = {( {\sum }_{i} {min ( 0 , {\overline{f} ( q )}_{i} - {f ( c )}_{i} , {f ( c )}_{i} - {f ( q )}_{i} )}^{2} )}^{\frac{1}{2}} & ( 7 )\end{matrix}$$

In Expression (6), “|f(q)ᵢ−f(c)ᵢ|₁” represents the absolute value of the difference between the upper limit of the i-th element of the feature amount of the input image q and the i-th element of the feature amount of the image c. The “|f(c)ᵢ−_f(q)ᵢ|₁” represents the absolute value of the difference between the i-th element of the feature amount of image c and the lower limit of the i-th element of the feature amount of input image q. The right-hand side of Expression (6) represents the square of the larger of these values squared and summed over all elements i in dimension n. This value is the upper limit ⁻d_{q}(f(q), f(c)) of d(f(q+δ), f(c)).

In Expression (7), “⁻f(q)ᵢ−f(c)ᵢ” represents the difference between the upper limit of the i-th element of the feature amount of the input image q and the i-th element of the feature amount of image c. “f(c)ᵢ−_f(q)ᵢ” represents the difference between the i-th element of the feature of image c and the lower limit of the i-th element of the feature amount of input image q. The right-hand side of Expression (7) represents the square of the smaller of these values and 0 squared and summed over all elements i in dimension n. This value is the lower limit _d_{q}(f(q), f(c)) of d(f(q+δ), f(c)).

When the robustness verification device 100 calculates the upper and lower limits of Expression (5) using the IBP-based calculation method described above, the norm in Expression (4) is the infinity norm.

The robustness verification device 100 may also calculate the upper and lower limits of ⁻d(f(q+δ), f(c)) using calculation methods other than IBP, in which case the norm in Expression (4) is not limited to the infinity norm.

The robustness verification device 100 performs (α, ß)-robustness verification using the upper limit d_{q}(f(q), f(c)) and lower limit _d_{q}(f(q), f(c)) of d(f(q+δ), f(c)).

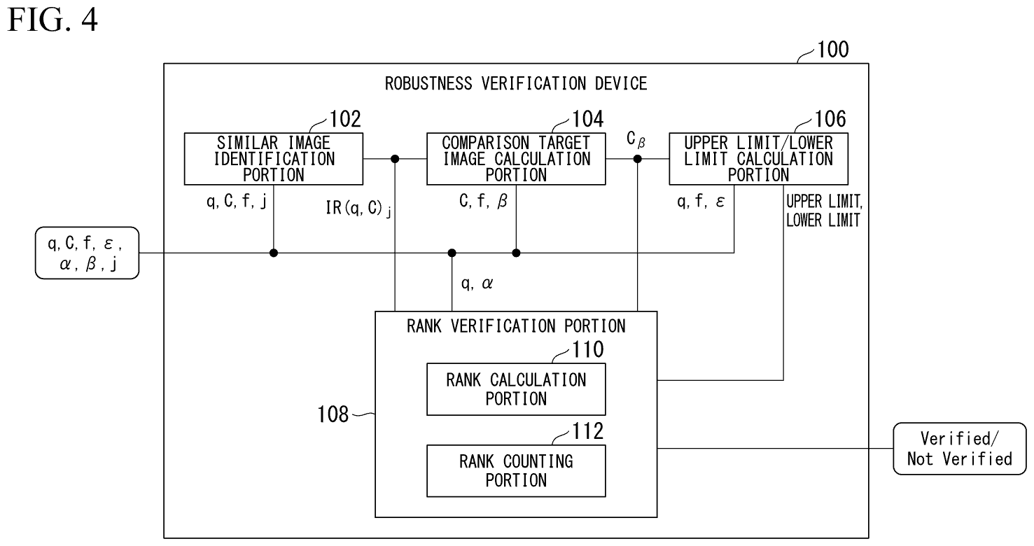

FIG. 4 is a schematic block diagram showing an example of the functional configuration of the robustness verification device 100 according to the first example embodiment. The robustness verification device 100 includes a similar image identification portion 102, a comparison target image calculation portion 104, an upper limit/lower limit calculation portion 106, and a rank verification portion 108. The rank verification portion 108 is provided with a rank calculation portion 110 and a rank counting portion 112. A query, input image q∈χ, a candidate image group C={c₁∈χ}(i=1 to N), feature amount extractor f, perturbation size ε, parameters α, ß and rank j are input to the robustness verification device 100. The robustness verification device 100 may be provided with a storage portion that stores the candidate image group C without the candidate image group C being input.

The similar image identification portion 102 receives the input image q, candidate image group C, feature amount extractor f, and rank j, and outputs the image IR(q, C)ⱼ that is the j-th most similar to the input image q in the candidate image group C. Specifically, the similar image identification portion 102 uses the feature amount extractor f to calculate the feature amounts f(q), f(cᵢ) (i=1 to N) of the input image q and each candidate image cᵢ∈C. Then, the similar image identification portion 102 calculates the Euclidean distance dist(f(q), f(cᵢ)) between the feature amount f(q) and each f(cᵢ). The similar image identification portion 102 then outputs the image that is j-th similar (j-th smallest distance) to the input image q as IR(q, C)ⱼ. The similar image identification portion 102 corresponds to the search of the content-based image retrieval device 900.

IR(q, C)ⱼ, the candidate image group C, the feature amount extractor f, and the parameter ß are input to the comparison target image calculation portion 104, which calculates the target image group C_{ß}, which is the set of images subject to robustness verification as shown in Expression (8).

$$\begin{matrix}[ Expression 8 ] & \\ {C}_{β} = \{ {IR ( q , C )}_{j} \} ⋃ \{ c \vert c ∈ C , β \leq {‖ f ( c ) - f ( {IR ( q , C )}_{j} ) ‖}_{q} \} & ( 8 )\end{matrix}$$

Specifically, the comparison target image calculation portion 104 includes IR(q, C)ⱼ in C_{ß}. The comparison target image calculation portion 104 calculates the feature amounts f(IR(q, C)ⱼ) and f(c) for IR(q, C)ⱼ and each target image c of the candidate image group C by the feature amount extractor f. Then, the comparison target image calculation portion 104 determines whether “∥f(c)−f(IR(q, C)ⱼ)∥_{q}”, the magnitude of the difference in the q-norm of the feature amounts, is equal to or greater than ß. If ß is greater than or equal to ß, the target image c is included in C_{ß}. The comparison target image calculation portion 104 includes the target image c in C_{ß}.

Note that ß is a parameter that determines the candidate images to be considered for ranking variation. ß represents that variation in ranking with images similar to IR(q, C)ⱼ is acceptable by not including images with a distance difference less than ß in C_{ß}. The larger the value of ß, the easier it is to achieve (α, ß)-robustness verification. Note that the q-norm can be any of 1, 2, p, or infinity norms.

The target image group C_{ß} to be verified for robustness, the input image q, the feature amount extractor f, and the perturbation size e are input to the upper limit/lower limit calculation portion 106, which, for each target image c ∈ C_{ß}, calculates the upper limit ⁻d_{q}(f(q), f(c)) and lower limit _d_{q}(f(q), f(c)) of d(f(q+δ), f(c)) satisfying Expression (5) for any δ satisfying Expression (4) described above.

Specifically, the upper limit/lower limit calculation portion 106 uses the aforementioned Interval Bound Propagation (IBP) to calculate, for each target image c ∈ C_{ß}, the upper limit ⁻d_{q}(f(q), f(c)) of d(f(q+δ), f(c)) shown in Expression (6) and the lower limit _d_{q}(f(q), f(c)) of d(f(q+δ), f(c)) shown in Expression (7).

The upper limit/lower limit calculation portion 106 is an example of the upper limit/lower limit calculation means.

The method by which the upper and lower limits of d(f(q+δ), f(c)) are calculated by the upper limit/lower limit calculation portion 106 is not limited to IBP, and other methods may be used.

The rank verification portion 108 receives as input the input image q, the image IR(q, C)ⱼ, the target image group C_{ß} that is subject to robustness verification, the upper limit ⁻d_{q}(f(q), f(c)) and lower limit _d_{q}(f(q), f(c)) of d(f(q+δ), f(c)) for each target image c∈C_{ß}, and the parameter α. Then, the rank verification portion 108 performs (α, ß)-robustness verification, i.e., verifies that the rank of image IR(q, C)ⱼ in the target image group CB when the input image is q+δ varies only at most α with respect to the rank of image IR(q, C)ⱼ when the input image is q.

The conditions for (α, ß)-robustness verification performed by the rank verification portion 108 are not based on the definition in Expression (2), but on the upper and lower limits of d(f(q+δ), f(c)). Specifically, the rank verification portion 108 verifies whether or not the following Expressions (9) and (10) are satisfied.

$$\begin{matrix}[ Expression 9 ] & \\ Rank ( q , {IR ( q , C )}_{j} {C}_{β} ) - α \leq 1 + {\sum }_{c ∈ {C}_{β} / {IR ( q , C )}_{j}} 1 [ \overline{{d}_{q}} ( f ( q ) , f ( c ) ) < \underline{{d}_{q}} ( f ( q ) , f ( {IR ( q , C )}_{j} ) ) ] & ( 9 )\end{matrix}$$

$$\begin{matrix}[ Expression 10 ] & \\ \vert {C}_{β} \vert - {\sum }_{c ∈ {C}_{β} / {IR ( q , C )}_{j}} 1 [ \overline{{d}_{q}} ( f ( q ) , f ( {IR ( q , C )}_{j} ) ) < \underline{{d}_{q}} ( f ( q ) , f ( c ) ) ] \leq Rank ( q , {IR ( q , C )}_{j} {C}_{β} ) + α & ( 10 )\end{matrix}$$

The rank calculation portion 110 of the rank verification portion 108 finds “Rank(q, IR(q, C)ⱼ, C_{ß})” in Expressions (9) and (10). “Rank (q, IR(q, C)ⱼ, C_{ß})” represents the rank of image IR(q, C)ⱼ in the target image group C_{ß} calculated by Expression (8) when the input image is q. Specifically, the rank calculation portion 110 calculates the rank by using the feature amount extractor f to find the Euclidean distance between each feature amount f(q), f(IR (q, C)ⱼ), and f(c) for q, IR(q, C)ⱼ, ∀c ∈ C_{ß}.

The rank counting portion 112 of the rank verification portion 108 calculates the right side of Expression (9) and the left side of Expression (10).

The rank counting portion 112 first calculates the right side of Expression (9). “⁻d_{q}(f(q), f(c))” is the upper limit of d(f(q+δ), f(c)) and “_d_{q}(f(q), f(IR(q, C)ⱼ))” is the lower limit of d(f(q+δ), f(IR(q, C)ⱼ)). The rank counting portion 112 counts 1 for “1┌d_{q}(f(q), f(c))≤d_{q}(f(q), f(IR(q, C)ⱼ))]” when the above upper limit is less than the above lower limit.

The rank counting portion 112 counts “1┌d_{q}(f(q), f(c))≤d_{q}(f(q), f(IR(q, C)ⱼ))]” for all elements c except IR(q, C)ⱼ from the target image group C_{ß}, and then adds 1 to the count.

The rank counting portion 112 then calculates the left side of Expression (10). “⁻d_{q}(f(q), f(IR(q, C)ⱼ)” is the upper limit of d(f(q+δ), f(IR(q, C)ⱼ)) and “_d_{q}(f(q), f(c))” is the lower limit of d(f(q+δ), f(c)). The rank counting portion 112 counts as 1 when the aforementioned upper limit is less than the aforementioned lower limit for “1┌Fd_{q}(f(q), f(IR(q, C)ⱼ))≤d_{q}(f(q), f(c))]”.

The rank counting portion 112 counts “1┌d_{q}(f(q), f(IR(q, C)ⱼ))≤d_{q}(f(q), f(c))]” for all elements c except IR(q, C)ⱼ from the target image group C_{ß}, and subtracts the counted value from the element number |C_{ß}| of C_{ß}.

The rank verification portion 108 verifies whether the value of the right side of the calculated Expression (9) is equal to or greater than “Rank(q, IR(q, C)ⱼ, C_{ß})-α”, and the value of the left side of the calculated Expression (10) is equal to or less than “Rank(q, IR(q, C)ⱼ, C_{ß})+α”. Here, α is a parameter indicating the amount of variation in ranking that is acceptable, i.e., that a ranking variation of at most α is permissible. The larger a is, the easier it is to verify (α, ß)-robustness.

If the condition is satisfied, the rank verification portion 108 outputs that (α, ß)-robustness is verified, and if the condition is not satisfied, it outputs that (α, ß)-robustness is not verified.

If the conditions in Expressions (9) and (10), which are verified by the rank verification portion 108, hold, then the conditions in Expression (2) of the (α, ß)-robustness verification are known to hold (sufficient conditions). Thus, the conditions in Expressions (9) and (10) mean that the rank of image IR(q, C)ⱼ in the target image group C_{ß} when the input image is q+δ varies only at most α with respect to the rank of image IR(q, C)ⱼ when the input image is q.

Because the upper limit/lower limit calculation portion 106 of the robustness verification device 100 uses the upper and lower limits of d(f(q+δ), f(c)), according to the definition of (α, ß)-robustness verification, there is a possibility that inputs which would originally be verified may be deemed as not verified in the robustness verification device 100.

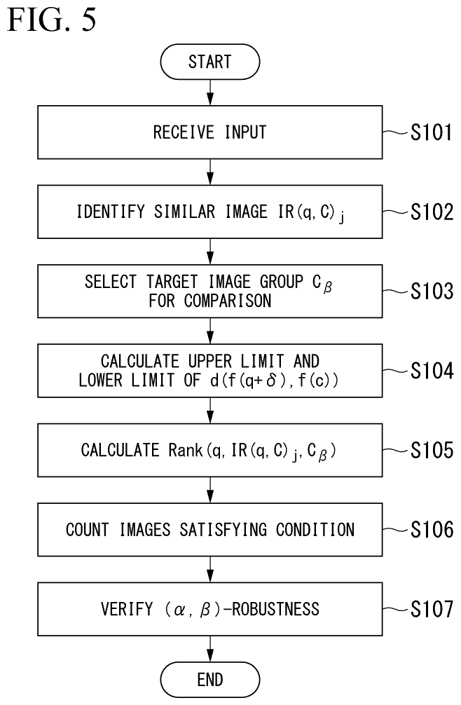

Next, the operation of the robustness verification device 100 is described with reference to FIG. 5. FIG. 5 is a flowchart showing an example of the processing procedure in which the robustness verification device 100 performs (α, ß)-robustness verification.

First, the robustness verification device 100 receives as input input image q∈χ, which is the query, candidate image group C={cᵢ∈_{χ}}(i=1 to N), feature amount extractor f, perturbation size e, parameters α, ß, and rank j (Step S101).

Next, the similar image identification portion 102 identifies the image IR(q, C)ⱼ that is the j-th most similar to the input image q in the candidate image group C. Specifically, the similar image identification portion 102 uses the feature amount extractor f to calculate the feature amounts f(q), f(cᵢ) (i=1 to N) of the input image q and each candidate image cᵢ∈C, and calculates the Euclidean distance dist (f(q), f(cᵢ)) between the feature amounts f(q) and each f(cᵢ). Then, the similar image identification portion 102 identifies the image with the j-th smallest distance from the input image q as IR(q, C)ⱼ(Step S102).

Next, the comparison target image calculation portion 104 selects the target image group C_{ß}, which is the set of images to be subject to robustness verification. Specifically, the comparison target image calculation portion 104 includes IR(q, C)ⱼ in C_{ß}. The comparison target image calculation portion 104 calculates the feature amounts f(IR(q, C)ⱼ) and f(c) for IR(q, C)ⱼ and each target image c of the candidate image group C. Then, the comparison target image calculation portion 104 includes that target image in CB if “∥f(c)−f(IR(q, C)ⱼ)∥_{q}”, the magnitude of the difference in the q-norm of the feature amounts, is equal to or greater than ß(Step S103).

Next, for each target image c in the target image group C_{ß}, the upper limit/lower limit calculation portion 106 calculates the upper limit ⁻d_{q}(f(q), f(c)) and lower limit _d_{q}(f(q), f(c)) of d(f(q+δ), f(c)) satisfying Expression (5) for any δ satisfying Expression (4) (Step S104).

Next, the rank calculation portion 110 of the rank verification portion 108 calculates Rank(q, IR(q, C)ⱼ, C_{ß}). Specifically, the rank calculation portion 110 calculates the rank by finding the Euclidean distance between each feature amount f(q), f(IR(q, C)ⱼ), f(c) of q, IR(q, C)ⱼ, •c∈C_{ß} using the feature amount extractor f (Step S105).

Next, the rank counting portion 112 of the rank verification portion 108 calculates the right side of Expression (9). That is, the rank counting portion 112 counts “1┌d_{q}(f(q), f(c))≤_d_{q}(f(q), f(IR(q, C)ⱼ))]” for all elements c except IR(q, C)ⱼ from the target image group C_{ß} in Expression (9), and then adds 1 to the count. The rank counting portion 112 also calculates the left side of Expression (10). In other words, the rank counting portion 112 counts “1┌d_{q}(f(q), f(IR(q, C)ⱼ))≤d_{q}(f(q), f(c))]” for all elements c except IR(q, C)ⱼ from the target image group C_{ß} in Expression (10), and subtracts the counted value from the element number |C_{ß}| of C_{ß} (Step S106).

Next, the rank verification portion 108 verifies whether the value of the right side of the calculated Expression (9) is equal to or greater than “Rank(q, IR(q, C)ⱼ, C_{ß})−α”, and the value of the left side of the calculated Expression (10) is equal to or less than “Rank(q, IR(q, C)ⱼ, C_{ß})+a”. If the condition holds, the rank verification portion 108 outputs that (α, ß)-robustness is verified, and if the condition does not hold, it outputs that (α, ß)-robustness is not verified (Step S107).

After Step S107, the robustness verification device 100 ends the process in FIG. 5.

The robustness verification device 100 may not perform (α, ß)-robustness verification only for a specific rank j, and may perform (α, ß)-robustness verification for multiple j, or for all j with 1≤j≤N.

As explained above, the similar image identification portion 102 identifies similar images IR(q, C)ⱼ. The comparison target image calculation portion 104 calculates the target image group C_{ß} to be subject to robustness verification. The upper limit/lower limit calculation portion 106 calculates the upper and lower limits of d(f(q+δ), f(c)) for each target image. The rank verification portion 108 verifies the conditions in Expressions (9) and (10).

Thereby, the robustness verification device 100 can perform (α, ß)-robustness verification, i.e., can verify that the rank of image IR(q, C)ⱼ in the target image group CB when the input image is q+δ varies only at most α with respect to the rank of image IR(q, C)ⱼ when the input image is q. In other words, the robustness verification device 100 can verify whether, in content-based image retrieval, the search results are not affected even if an adversarial example in which adversarial perturbation is applied to an input image that is a query is applied.

For each target image c in the target image group C_{ß} subject to robustness verification, the upper limit/lower limit calculation portion 106 calculates the upper limit ⁻d_{q}(f(q), f(c)) and lower limit _d_{q}(f(q), f(c)) of d(f(q+δ), f(c)) for any δ satisfying Expression (4). The robustness verification device 100 then uses these upper and lower limits to perform (α, ß)-robustness verification.

This allows the robustness verification device 100 to perform (α, ß)-robustness verification with a small amount of computation (practical computation time).

In addition, the comparison target image calculation portion 104 uses the parameter ß to allow for variation in ranking when determining the target image group CB.

This allows the robustness verification device 100 to adjust the accuracy of the verification, such as making (α, ß)-robustness verification easier as ß increases.

The rank verification portion 108 also uses the parameter α to determine the amount of rank that is acceptable.

This allows the robustness verification device 100 to adjust the accuracy of the verification, such as the larger a is, the easier it is for (α, ß)-robustness verification to be performed.

### Second Example Embodiment

Next, the second example embodiment of the present invention shall be described. The second example embodiment is a robustness verification device 200 that verifies the robustness of the content-based image retrieval device 900 against candidate attacks.

Let q be the input image that is the query of the content-based image retrieval device 900. Let IR(q, C)ⱼ be the j-th similar image to q that the content-based image retrieval device 900 retrieves from the candidate image group C={cᵢ∈χ}(i=1 to N) when the input image q is input. The candidate image group to which noise δᵢ (i=1 to N) of magnitude e or less is added is denoted as ˜C={cᵢ+δᵢ|cᵢ∈C}(i=1 to N).

In this case, the robustness verification device 200 verifies whether the ranking of IR(q, C)ⱼ does not vary that much, even if the candidate image group of the content-based image retrieval device 900 is the noise-added candidate image group ˜C. Specifically, the robustness verification device 200 verifies whether the ranking of IR(q, C)ⱼ varies only at most α from the ranking j when the candidate image group is C even if the candidate image group of the content-based image retrieval device 900 is ˜C.

[α-robustness verification against candidate attacks]

First, α-robustness verification, which is a fundamental concept in verifying robustness with the robustness verification device 200, shall be described.

α-robustness verification against query attacks is defined as follows.

Let a be a natural number greater than or equal to 0. At this time, with respect to

$$\begin{matrix}[ Expression 11 ] & \\ ∀ {δ}_{1} , … , ∀ {δ}_{N} ∈ \{ δ \vert δ ∈ 𝒳 , {‖ δ ‖}_{p} \leq ϵ \} & ( 11 )\end{matrix}$$

IR(q, C)ⱼ is considered to be α-robustness verified if

$$\begin{matrix}[ Expression 12 ] & \\ j - α \leq Rank ( q , {IR ( q , C )}_{j} , \tilde{C} ) \leq j + α & ( 12 )\end{matrix}$$

holds true. Here,

$$\begin{matrix}[ Expression 13 ] & \\ \tilde{C} = {\{ {c}_{i} + {δ}_{i} \vert {c}_{i} ∈ C \}}_{i = 1}^{N} & ( 13 )\end{matrix}$$

is.

Expression (11) represents the range of noise Si applied to each image cᵢ (i=1 to N) of the candidate image group C. X represents the input space of images. “δ∈χ” denotes that δ is also an element of the input space of images. “∥δ∥ₚ” denotes the infinity norm L_{∞} of δ. “∥δ∥ₚ≤ε” indicates that the magnitude of δ is less than or equal to ε when the infinity norm L_{∞} of δ is taken. This is illustrated in FIG. 2. “∀δ₁, . . . , ∀δ_{N}∈ {δ∈χ, ∥δ∥ₚ≤ε}” denotes that each noise δᵢ is an arbitrary element of the set satisfying this condition. The p-norm is not limited to the infinity norm, but can be 1, 2, or p norms.

Expression (13) expresses the set of images ˜C(hereafter referred to as the target image group) subject to the robustness verification in Expression (12). The “˜C={cᵢ+δᵢ| cᵢ∈C}(i=1 to N)” indicates that for each candidate image cᵢ of the candidate image group C, the image cᵢ+δᵢ with any noise δᵢ is an element of the target image group ˜C.

Note that, ß, a parameter that determines the candidate images to be considered for ranking changes, is not introduced, as in the case of query attacks. This is because the robustness verification in a candidate attack assumes that noise can ride on any candidate image cᵢ (i=1 to N) in the candidate image group C. In other words, this is because, assuming the feature amount extractor f, since f(cᵢ>(i=1 to N) can be modified by noise, it is not possible to exclude similar images based on distance in the feature amount space, as in the case of a query attack.

Expression (12) represents the specific condition for α-robustness verification. Rank (q, c, C) represents the rank of image c in the candidate image group C with respect to similarity using the feature amount extractor f when the input image is q. The feature amount extractor f is the feature amount extractor of the content-based image retrieval device 900. Therefore, “Rank (q, IR(q, C)ⱼ, ˜C)” represents the rank of image IR(q, C)ⱼ in the target image group ˜C obtained by Expression (13), where the input image is q. Also, “j” stands for Rank (q, IR(q, C)ⱼ, C), which is the rank j of image IR(q, C)ⱼ when the input image in candidate image group C is q. Therefore, Expression (12) expresses the condition that the rank of image IR(q, C)ⱼ in the target image group ˜C calculated by Expression (13) when the input image is q varies only at most α with respect to the rank of image IR(q, C)ⱼ when the input image is q. α is a parameter indicating the amount of variation in rank that is acceptable, i.e. that a ranking variation of at most α is acceptable. The larger a is, the easier it is to verify α-robustness.

### [Robustness Verification Device 200]

The robustness verification device 200 performs the α-robustness verification described above, but accurate computation of α-robustness verification is difficult due to computational complexity issues. In other words, it is difficult for the robustness verification device 200 to verify Expression (12) for any δ that satisfies Expression (11). Therefore, the robustness verification device 200, with respect to

$$\begin{matrix}[ Expression 14 ] & \\ ∀ δ ∈ \{ δ \vert δ ∈ 𝒳 {‖ δ ‖}_{p} \leq ϵ \} & ( 14 )\end{matrix}$$

utilizes the ability to calculate the upper and lower limits of d(f(q), f(c+δ)) with minimal computational effort. Here, q is the input image while c is an element of the candidate image group C.

In other words, the robustness verification device 200 calculates the lower and upper limits that satisfy

$$[ Expression 15 ]$$

$$\underline{{d}_{c}} ( f ( q ) , f ( c ) ) \leq d ( f ( q ) , f ( c + δ ) ) \leq \overline{{d}_{c}} ( f ( q ) , f ( c ) ) \qquad ( 15 )$$

where “d(f(q), f(c+δ))” is the Euclidean distance d(f(q), f(c+δ)) between the feature amount f(q) of the input image q and the feature amount f(c+δ) of image c with noise δ. “⁻d_{c}(f(q), f(c))” is the upper limit of d(f(q), f(c+δ)) for any δ satisfying Expression (14). The c in “⁻d_{c}” indicates that noise has been added to c. “_d_{c}(f(q), f(c))” is the lower limit of d(f(q), f(c+δ)) for any δ satisfying Expression (14). The c in “_d_{c}” indicates that noise has been added to c.

The robustness verification device 200 performs calculations using, for example, Interval Bound Propagation (IBP), a well-known technique described in the aforementioned reference. IBP is a method for computing the upper and lower limits of each element i of the feature amount f(x+δ) by sequentially computing the upper and lower limits of each element of the intermediate layer representation in each layer when an image x+δ with noise δ added is input for noise δ∈{δ|∥δ∥_{∞}≤ε} with a magnitude in the infinity norm equal to or less than ε. Here, i represents the i-th element (1≤i≤n) of the feature amount, assuming that the feature amount is an n-dimensional vector.

The robustness verification device 200 uses IBP to calculate the upper limit ⁻f(q)ᵢ and lower limit _f(q)ᵢ of f(c+δ)ᵢ, where i is the i-th element of the n-dimensional vector. The robustness verification device 200, using the upper limit and lower limit, then calculates the upper limit ⁻d_{c}(f(q), f(c)) and lower limit _d_{c}(f(q), f(c)) of d(f(q), f(c+δ) with Expressions (16) and (17), respectively.

$$[ Expression 16 ]$$

$$\overline{{d}_{c}} ( f ( q ) , f ( c ) ) = {( {\sum }_{i} {max ( {\vert {\overline{f} ( c )}_{i} - {f ( q )}_{i} \vert}_{1} , {\vert {f ( q )}_{i} - {\underline{f} ( c )}_{i} \vert}_{1} )}^{2} )}^{\frac{1}{2}} \qquad ( 16 )$$

$$[ Expression 17 ]$$

$$\underline{{d}_{c}} ( f ( q ) , f ( c ) ) = {( {\sum }_{i} {min ( 0 , {\overline{f} ( c )}_{i} - {f ( q )}_{i} , {f ( q )}_{i} - {\underline{f} ( c )}_{i} )}^{2} )}^{\frac{1}{2}} \qquad ( 17 )$$

In Expression (16), “|⁻ f(c)ᵢ−f(q)ᵢ|₁” represents the absolute value of the difference between the upper limit of the i-th element of the feature amount of the image c and the i-th element of the feature amount of the input image q. The “|f(q)ᵢ−_f(c)ᵢ|₁” represents the absolute value of the difference between the i-th element of the feature amount of input image q and the lower limit of the i-th element of the feature amount of image c. The right-hand side of Expression (16) represents the square of the larger of these values squared and summed over all elements i in dimension n. This value is the upper limit ⁻d_{c}(f(q), f(c)) of d(f(q), f(c+δ)).

In Expression (17), “⁻f(c)ᵢ−f(q)ᵢ” represents the difference between the upper limit of the i-th element of the feature amount of the image c and the i-th element of the feature amount of input image q. “f(q)ᵢ−_f(c)ᵢ” represents the difference between the i-th element of the feature of input image q and the lower limit of the i-th element of the feature amount of image c. The right-hand side of Expression (17) represents the square of the smaller of these values and 0 squared and summed over all elements i in dimension n. This value is the lower limit _d_{c}(f(q), f(c)) of d(f(q), f(c+δ)).

When the robustness verification device 200 calculates the upper and lower limits of Expression (15) using the IBP-based calculation method described above, the norm in Expression (14) is the infinity norm.

The robustness verification device 200 may also calculate the upper and lower limits of d(f(q), f(c+δ)) using calculation methods other than IBP, in which case the norm in Expression (4) is not limited to the infinity norm.

The robustness verification device 200 performs α-robustness verification by using the upper limit ⁻d_{c}(f(q), f(c)) and lower limit _d_{c}(f(q), f(c)) of d(f(q), f(c+δ)).

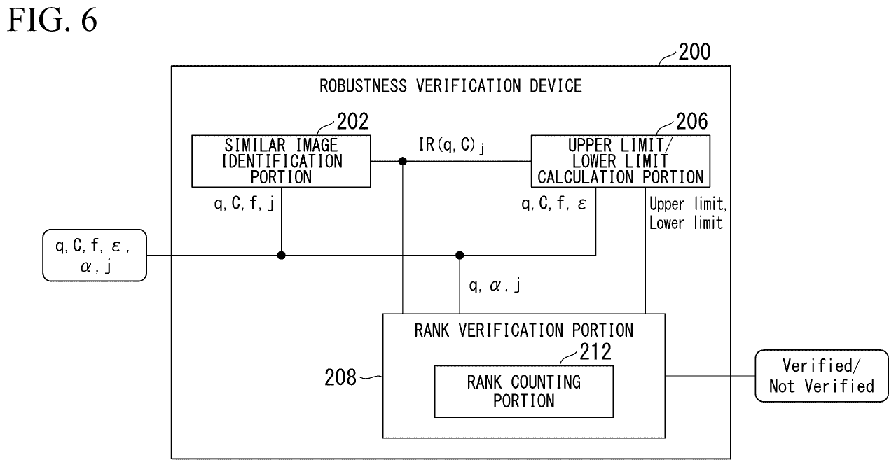

FIG. 6 is a schematic block diagram showing an example of the functional configuration of the robustness verification device 200 according to the second example embodiment. The robustness verification device 200 includes a similar image identification portion 202, an upper limit/lower limit calculation portion 206, and a rank verification portion 208. The rank verification portion 208 is provided with a rank counting portion 212. A query, input image q∈χ, a candidate image group C={cᵢ∈χ}(i=1 to N), feature amount extractor f, perturbation size ε, parameter α and rank j are input to the robustness verification device 200. The robustness verification device 200 may be provided with a storage portion that stores the candidate image group C without the candidate image group C being input.

The similar image identification portion 202 receives the input image q, candidate image group C, feature amount extractor f, and rank j, and outputs the image IR(q, C)ⱼ that is the j-th most similar to the input image q in the candidate image group C. Specifically, the similar image identification portion 202 uses the feature amount extractor f to calculate the feature amounts f(q), f(cᵢ) (i=1 to N) of the input image q and each candidate image cᵢ∈C. Then, the similar image identification portion 202 calculates the Euclidean distance dist(f(q), f(cᵢ)) between the feature amount f(q) and each f(cᵢ). The similar image identification portion 202 then outputs the image that is j-th similar (j-th smallest distance) to the input image q as IR(q, C)ⱼ. The similar image identification portion 202 corresponds to the search of the content-based image retrieval device 900.

The candidate image group C, the input image q, the feature amount extractor f, and the perturbation size e are input to the upper limit/lower limit calculation portion 206, which, for each target image c ∈ C, calculates the upper limit ⁻d_{c}(f(q), f(c)) and lower limit _d_{c}(f(q), f(c)) of d(f(q), f(c+δ)) satisfying Expression (5) for any δ satisfying Expression (14) described above.

Specifically, the upper limit/lower limit calculation portion 206 uses the aforementioned Interval Bound Propagation (IBP) to calculate, for each target image c ∈ C_{ß}, the upper limit ⁻d_{c}(f(q), f(c)) of d(f(q), f(c+δ)) shown in Expression (16) and the lower limit _d_{c}(f(q), f(c)) of d(f(q), f(c+δ)) shown in Expression (17).

The method by which the upper and lower limits of d(f(q), f(c+δ)) are calculated by the upper limit/lower limit calculation portion 206 is not limited to IBP, and other methods may be used.

The rank verification portion 208 receives as input the input image q, the image IR(q, C)ⱼ, the candidate image group C, the upper limit ⁻d_{c}(f(q), f(c)) and lower limit _d_{c}(f(q), f(c)) of d(f(q), f(c+δ)) for each target image c∈C, and the parameter α. Then, the rank verification portion 208 performs α-robustness verification, i.e., verifies, when the target image group with noise added to the candidate image group C is denoted as ˜C, that the rank of image IR(q, C)ⱼ in the target image group ˜C when the input image is q varies only at most α with respect to the rank j of image IR(q, C)ⱼ when the input image is q.

The conditions for α-robustness verification performed by the rank verification portion 208 are not based on the definition in Expression (12), but on the upper and lower limits of d(f(q), f(c+δ)). Specifically, the rank verification portion 208 verifies whether or not the following Expressions (18) and (19) are satisfied.

$$[ Expression 18 ]$$

$$j - α \leq 1 + {\sum }_{c ∈ C / {IR ( q , C )}_{j}} 1 [ \overline{{d}_{c}} ( f ( q ) , f ( c ) ) < \underline{{d}_{c}} ( f ( q ) , f ( {IR ( q , C )}_{j} ) ) ] \qquad ( 18 )$$

$$[ Expression 19 ]$$

$$N - {\sum }_{c ∈ C / {IR ( q , C )}_{j}} 1 [ \overline{{d}_{c}} ( f ( q ) , f ( {IR ( q , C )}_{j} ) ) < \underline{{d}_{c}} ( f ( q ) , f ( c ) ) ] \leq j + α \qquad ( 19 )$$

The rank counting portion 212 of the rank verification portion 208 calculates the right side of Expression (18) and the left side of Expression (19).

The rank counting portion 212 first calculates the right side of Expression (18). “⁻d_{c}(f(q), f(c))” is the upper limit of d(f(q), f(c+δ)) while the “_d_{c}(f(q), f(IR(q, C)ⱼ))” is the lower limit of d(f(q), f(IR(q, C)ⱼ+δ)). The rank counting portion 212 counts as 1 when the aforementioned upper limit is less than the aforementioned lower limit for “1┌d_{c}(f(q), f(c))<_d_{c}(f(q), f(IR(q, C)ⱼ))]”.

The rank counting portion 212 counts “1┌d_{c}(f(q), f(c))<_d_{c}(f(q), f(IR(q, C)ⱼ))]” for all elements c except IR(q, C)ⱼ from the candidate image group C, and then adds 1 to the count.

The rank counting portion 212 then calculates the left side of Expression (19). “⁻d_{c}(f(q), f(IR(q, C)ⱼ))” is the upper limit of d(f(q), f(IR(q, C)ⱼ+δ while the “_d_{c}(f(q), f(c))” is the lower limit of d(f(q), f(c+δ)). The rank counting portion 212 counts as 1 when the aforementioned upper limit is less than the aforementioned lower limit for “1┌d_{c}(f(q), f(IR(q, C)ⱼ))<_d_{c}(f(q), f(c))]”.

The rank counting portion 212 counts “1┌d_{c}(f(q), f(IR(q, C)ⱼ))<_d_{c}(f(q), f(c))]” for all elements c except IR(q, C)ⱼ from the candidate image group C, and subtracts the counted value from the element number N of C.

The rank verification portion 208 verifies whether the value of the right side of the calculated Expression (18) is equal to or greater than “j-α”, and the value of the left side of the calculated Expression (19) is equal to or less than “j+α”. Note that “j” is Rank(q, IR(q, C)ⱼ, C), which is the rank of image IR(q, C)ⱼ in terms of similarity with input image q when no noise is added to candidate image group C. Here, a is a parameter indicating the amount of variation in ranking that is permitted, i.e., that a ranking variation of at most α is permissible. The larger a is, the easier it is to verify α-robustness.

If the condition holds, the rank verification portion 208 outputs that α-robustness is verified, and if the condition does not hold, it outputs that α-robustness is not verified.

If the conditions in Expressions (18) and (19), which are verified by the rank verification portion 208, hold, then the condition in Expression (12) of the α-robustness verification is known to hold (sufficient conditions). Accordingly, the conditions in Expressions (18) and (19) mean that, when the target image group with noise added to the candidate image group C is denoted as ˜C, the rank of image IR(q, C)ⱼ in the target image group ˜C when the input image is q varies only at most α with respect to the rank j of image IR(q, C)ⱼ when the input image is q.

Note that since the upper limit/lower limit calculation portion 206 of the robustness verification device 200 uses the upper and lower limits of d(f(q), f(c+δ)), according to the definition of α-robustness verification, there is a possibility that inputs which would originally be verified may be deemed as not verified in the robustness verification device 200.

As with the robustness verification device 100, the rank verification portion 208 of the robustness verification device 200 may include a rank calculation portion 210. In this case, the rank calculation portion 210 outputs the input “j” to the robustness verification device 200 as it is. “j” is Rank(q, IR(q, C)ⱼ, C), which is the rank of image IR(q, C)ⱼ in terms of similarity with input image q in a case where no noise is added to candidate image group C.

Next, the operation of the robustness verification device 200 shall be described with reference to FIG. 6. FIG. 6 is a flowchart showing an example of the processing procedure in which the robustness verification device 200 performs α-robustness verification.

First, the robustness verification device 200 receives as input input image q∈χ, which is the query, candidate image group C={cᵢ∈χ}(i=1 to N), feature amount extractor f, perturbation size ε, parameter α, and rank j (Step S201).

Next, the similar image identification portion 202 identifies the image IR(q, C)ⱼ that is the j-th most similar to the input image q in the candidate image group C. Specifically, the similar image identification portion 202 uses the feature amount extractor f to calculate the feature amounts f(q), f(cᵢ) (i=1 to N) of the input image q and each candidate image cᵢ∈C, and calculates the Euclidean distance dist (f(q), f(cᵢ)) between the feature amounts f(q) and each f(cᵢ). Then, the similar image identification portion 202 identifies the image with the j-th smallest distance from the input image q as IR(q, C)ⱼ(Step S202).

Next, for each target image c in the candidate image group C, the upper limit/lower limit calculation portion 206 calculates the upper limit ⁻d_{c}(f(q), f(c)) and lower limit _d_{c}(f(q), f(c)) of d(f(q), f(c+δ)) satisfying Expression (15) for any δ satisfying Expression (14) (Step S203).

Next, the rank counting portion 212 of the rank verification portion 208 calculates the right side of Expression (18). That is, the rank counting portion 212 counts “1┌d_{c}(f(q), f(c))<_d_{c}(f(q), f(IR(q, C)ⱼ))]” for all elements c except IR(q, C)ⱼ from the candidate image group C in Expression (18), and then adds 1 to the count. The rank counting portion 212 also calculates the left side of Expression (19). That is, the rank counting portion 212 counts “1┌d_{c}(f(q), f(IR(q, C)ⱼ))<_d_{c}(f(q), f(c))]” for all elements c except IR(q, C)ⱼ from the candidate image group C in Expression (19), and subtracts the counted value from the element number N of C (Step S204).

Next, the rank verification portion 208 verifies whether the value of the right side of the calculated Expression (18) is equal to or greater than “j−α”, and the value of the left side of the calculated Expression (19) is equal to or less than “j+α”. If the condition holds, the rank verification portion 208 outputs that α-robustness is verified, and if the condition does not hold, it outputs that α-robustness is not verified (Step S205).

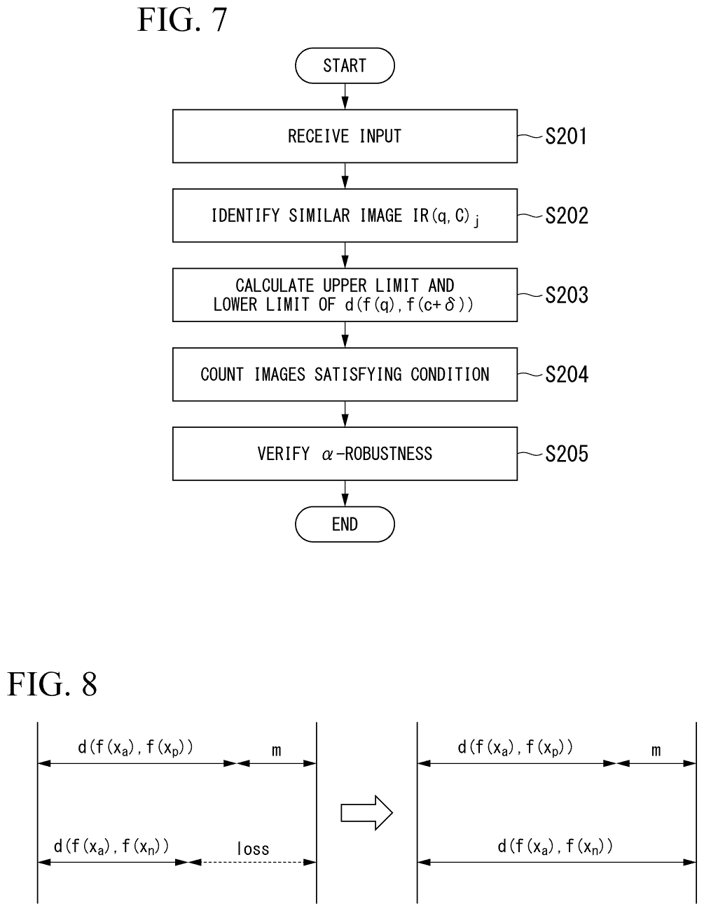

After Step S205, the robustness verification device 200 ends the process in FIG. 7.

The robustness verification device 200 may not perform α-robustness verification only for a specific rank j, and may perform α-robustness verification for multiple j, or for all j with 1≤j≤N.

As explained above, the similar image identification portion 202 identifies similar images IR(q, C)ⱼ. The upper limit/lower limit calculation portion 206 calculates the upper and lower limits of d(f(q), f(c+δ)) for each target image. The rank verification portion 208 verifies the conditions in Expressions (18) and (19).

Thereby, the robustness verification device 200 can perform α-robustness verification, i.e., can verify, in a case where the target image group with noise added to the candidate image group C is denoted as ˜C, that the rank of image IR(q, C)ⱼ in the target image group ˜C in a case where the input image is q varies only at most α with respect to the rank j of image IR(q, C)ⱼ in a case where the input image is q. That is, the robustness verification device 200 can verify the degree of influence on search results in content-based image retrieval in a case where an adversarial example to which adversarial perturbation is added is applied.

For each target image c in the candidate image group C, the upper limit/lower limit calculation portion 206 calculates the upper limit ⁻d_{c}(f(q), f(c)) and lower limit _d_{c}(f(q), f(c)) of d(f(q), f(c+δ)) for any δ satisfying Expression (14). The robustness verification device 200 then uses these upper and lower limits to perform (α, ß)-robustness verification.

This allows the robustness verification device 200 to perform α-robustness verification with a small amount of computation (practical computation time).

The rank verification portion 208 also uses the parameter α to determine the amount of variation in rank that is acceptable.

This allows the robustness verification device 200 to adjust the accuracy of the verification, such as the larger a is, the easier it is for α-robustness verification to be performed.

### Third Example Embodiment

In content-based image retrieval using the feature amount extractor, an image that is j-th most similar to the input image q in the candidate image group C is referred to as the similar image IR(q, C)ⱼ.

As mentioned above, in (α, ß)-robustness verification and α-robustness verification, in a case where any noise δ with a magnitude less than or equal to a predetermined value e is added to the input image q or the candidate image c, it is difficult to calculate the variation in the ranking of the similar image IR(q, C)ⱼ in the candidate image group with respect to the input image.

Therefore, in a case where the feature extraction model is set to f, the distance to d, and the magnitude of noise to a predetermined value e, for any noise δ of magnitude e or less, the robustness verification devices 100 and 200 of the first and second example embodiments utilize the ability to calculate the upper and lower limits of distance d(f(q+δ), f(c)), and d(f(q), f(c+q)) in the feature space in a case where the noise is added to an image with minimal computational effort. The upper and lower limits here refer to the values calculated by Expressions (6) and (7), and Expressions (16) and (17). The upper and lower limits are then used to calculate the variation in the ranking of the similar image IR(q, C)ⱼ with respect to the input image in the candidate image group in a case where the noise δ is added to the input image q or candidate image c.

However, the success rate of robustness verification against the query attack and candidate attack depends on the upper and lower limits of the distance d(f(q+δ), f(c)) and d(f(q), f(c+q)) in the feature space in a case where the noise δ is added to the image, and the closer these upper and lower limits are to the distance d(f(q), f(c)) in the feature space in a case where no noise is added, the better the robustness can be verified. In other words, if the distance d(f(q+δ), f(c)) or d(f(q), f(c+q)) is significantly different from the distance d(f(q), f(c)), robustness verification cannot be successfully performed.

Therefore, the following third to sixth example embodiments deal with a learning device that performs learning of the feature amount extractor f such that, for images x₁ and x₂, the upper limit ⁻d(f(x₁), f(x₂)) and the lower limit _d(f(x₁), f(x₂)) of the distance in the feature space by the feature amount extractor f become close to the distance d(f(x₁), f(x₂)).

### [Triplet Loss]

In the present invention, triplet loss is employed for learning of the feature amount extractor f. Triplet loss is a learning model used in quantitative learning. The triplet loss is given D={(xₐ, xₚ, xₙ)ᵢ}(i=1 to N) as training data. xₐ is called the anchor, xₚ is called the positive sample, and xₙ is called the negative sample. The anchor xₐ and the positive sample xₚ are data belonging to the same class, while the anchor xₐ and the negative sample xₙ are data belonging to different classes. The triplet (xₐ, xₚ, xₙ) is called a triplet.

Triplet loss performs learning of the feature amount extractor f so as to reduce the distance between a pair consisting of the anchor xₐ and a positive sample xₚ belonging to the same class and increase the distance between a pair consisting of the anchor xₐ and a negative sample xₙ belonging to a different class. Specifically, triplet loss involves using the training data D to train the feature amount extractor f so as to minimize a loss function, called Triplet or TripletLoss, represented by Expression (20).

$$[ Expression 20 ]$$

$$Triplet ( {x}_{a} , {x}_{p} , {x}_{n} ) = max ( d ( f ( {x}_{a} ) , f ( {x}_{p} ) ) - d ( f ( {x}_{a} ) , f ( {x}_{n} ) ) + m , 0 ) \qquad ( 20 )$$

In Expression (20), “f(xₐ)”, “f(xₚ)”, and “f(xₙ)” represent feature amounts by the feature amount extractor f for xₐ, xₚ, xₙ, respectively. “d(f(xₐ), f(xₚ))” represents the distance between f(xₐ) and f(xₚ), and “d(f(xₐ), f(xₙ))” represents the distance between f(xₐ) and f(xₙ). “m” is a positive real constant representing the hyperparameter for the margin, meaning that the two distances d(f(xₐ), f(xₚ)) and d(f(xₐ), f(xₙ)) should be m apart. The value of the loss function is the value of “d(f(xₐ), f(xₚ))−d(f(xₐ), f(xₙ))+m” if the value is positive and 0 if it is negative, depending on the max function.

FIG. 8 shows the minimization of the triplet loss function. Minimizing the TripletLoss loss function expressed in Expression (20) means that the feature amount extractor f is learned to transition from the left state in FIG. 8 to the right state. This means decreasing the distance between the anchor xₐ and the positive sample xₚ belonging to the same class and increasing the distance between the anchor xₐ and the negative sample xₙ belonging to a different class.

In the case of the present invention, the data is an image.

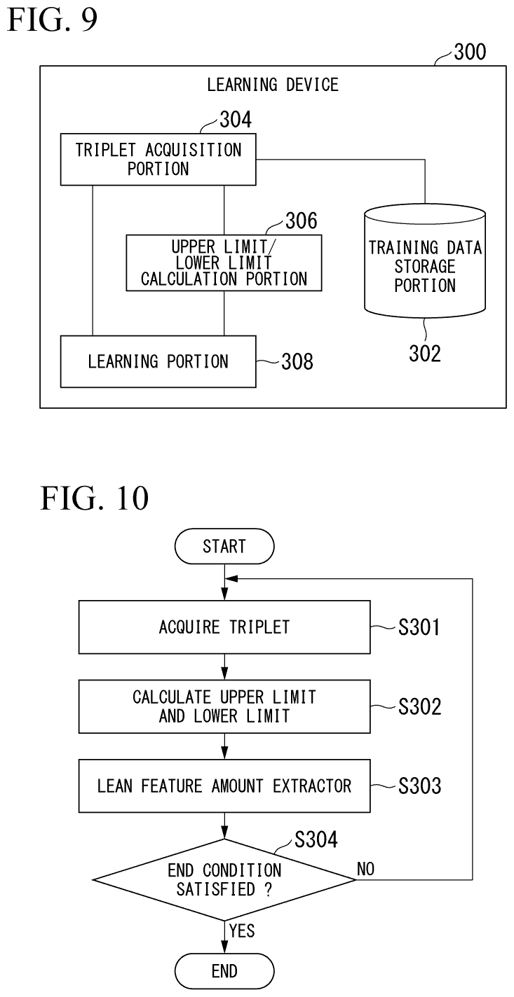

FIG. 9 is a schematic block diagram showing an example of the functional configuration of the learning device 300 according to the third example embodiment. The learning device 300 is provided with a training data storage portion 302, a triplet acquisition portion 304, an upper limit/lower limit calculation portion 306, and a learning portion 308. The learning device 300 according to the third example embodiment trains the feature amount extractor f using the training data D={(x, x+, x−)ᵢ}(i=1 to N), which does not overlap with the input image q, which is the query, or the candidate image of the candidate image group C.

The learning portion 308 is an example of a learning means.

The training data storage portion 302 stores training data D={(x, x+, x−)ᵢ}(i=1 to N). x, x+, x− are images. (x, x+, x−) is the triplet described above. For an anchor x, x+ is a positive sample, an image belonging to the same class as x. For an anchor x, x− is a negative sample, an image belonging to a different class than x.

The triplet acquisition portion 304 acquires each triplet (x, x+, x−) from the training data storage portion 302 and outputs them to the upper limit/lower limit calculation portion and the learning portion 308.

The upper limit/lower limit calculation portion 306 receives the triplet (x, x+, x−) from the triplet acquisition portion 304. The upper limit/lower limit calculation portion 306, for the anchor x and positive sample x+, first calculates the upper and lower limits of d(f(x), f(x+)) satisfying Expression (21) using Expressions (22) and (23), respectively.

$$[ Expression 21 ]$$

$$\underline{d} ( f ( x ) , f ( {x}_{+} ) ) \leq d ( f ( x ) , f ( {x}_{+} ) ) \leq \overline{d} ( f ( x ) , f ( {x}_{+} ) ) \qquad ( 21 )$$

$$[ Expression 22 ]$$

$$\overline{d} ( f ( x ) , f ( {x}_{+} ) ) = {( {\sum }_{i} {max ( {\vert {\overline{f} ( x )}_{i} - {f ( {x}_{+} )}_{i} \vert}_{1} , {\vert {f ( {x}_{+} )}_{i} - {\underline{f} ( x )}_{i} \vert}_{1} )}^{2} )}^{\frac{1}{2}} \qquad ( 22 )$$

$$[ Expression 23 ]$$

$$\underline{d} ( f ( x ) , f ( {x}_{+} ) ) = {( {\sum }_{i} {min ( 0 , {\overline{f} ( x )}_{i} - {f ( {x}_{+} )}_{i} , {f ( {x}_{+} )}_{i} - {\underline{f} ( x )}_{i} )}^{2} )}^{\frac{1}{2}} \qquad ( 23 )$$

The upper limit/lower limit calculation portion 306 performs calculations using Interval Bound Propagation (IBP), a known technique described in the aforementioned reference. The upper limit/lower limit calculation portion 306 calculates the upper limit ⁻f(x)ᵢ and lower limit _f(x)ᵢ of f(x)ᵢ using IBP, where i represents the i-th element of the n-dimensional vector. Using these upper and lower limits, the upper limit ⁻d(f(x), f(x+)) and lower limit _d(f(x), f(x+)) of d(f(x), f(x+)) are calculated using Expressions (22) and (23), respectively.

In Expression (22), “|⁻f(x)ᵢ−f(x+)ᵢ|₁” represents the absolute value of the difference between the upper limit of the i-th element of the feature amount of image x and the i-th element of the feature amount of image x+. “|f(x+)ᵢ−_f(x)ᵢ|₁” represents the absolute value of the difference between the i-th element of the feature amount of image x+ and the lower limit of the i-th element of the feature amount of image x. The right-hand side of Expression (22) represents the square of the larger of these values squared and summed over all elements i in dimension n. This value is the upper limit ⁻d(f(x), f(x+)) of d(f(x), f(x+)).

In Expression (23), “f(x)ᵢ−f(x+)ᵢ” represents the difference between the upper limit of the i-th element of the feature amount of image x and the i-th element of the feature amount of image x+. The “f(x)ᵢ-f(x+)ᵢ” represents the difference between the i-th element of the feature amount of image x+ and the lower limit of the i-th element of the feature amount of image x. The right-hand side of Expression (23) represents the square of the smaller of these values and 0 squared and summed over all elements i in dimension n. This value is the lower limit _d(f(x), f(x+)) of d(f(x), f(x+)).

Next, the upper limit/lower limit calculation portion 306, for the anchor x and negative sample x−, calculates the upper and lower limits of d(f(x), f(x−)) satisfying Expression (24) using Expressions (25) and (26), respectively, using IBP in the same manner. The meanings of Expressions (25) and (26) are the same as Expressions (22) and (23), respectively.

$$[ Expression 24 ]$$

$$\underline{d} ( f ( x ) , f ( {x}_{-} ) ) \leq d ( f ( x ) , f ( {x}_{-} ) ) \leq \overline{d} ( f ( x ) , f ( {x}_{-} ) ) \qquad ( 24 )$$

$$[ Expression 25 ]$$

$$\overline{d} ( f ( x ) , f ( {x}_{-} ) ) = {( {\sum }_{i} {max ( {\vert {\overline{f} ( x )}_{i} - {f ( {x}_{-} )}_{i} \vert}_{1} , {\vert {f ( {x}_{-} )}_{i} - {\underline{f} ( x )}_{i} \vert}_{1} )}^{2} )}^{\frac{1}{2}} \qquad ( 25 )$$

$$[ Expression 26 ]$$

$$\underline{d} ( f ( x ) , f ( {x}_{-} ) ) = {( {\sum }_{i} {min ( 0 , {\overline{f} ( x )}_{i} - {f ( {x}_{-} )}_{i} , {f ( {x}_{-} )}_{i} - {\underline{f} ( x )}_{i} )}^{2} )}^{\frac{1}{2}} \qquad ( 26 )$$

The upper limit/lower limit calculation portion 306 outputs the calculated upper and lower limits to the learning portion 308.

The learning portion 308 trains the feature amount extractor f using triplet loss. Specifically, the learning portion 308 receives the triplet (x, x+, x−) and the calculated upper and lower limits and performs learning of the feature amount extractor f so that the loss function shown in Expression (27) is minimized.

$$[ Expression 27 ]$$

$${κ}_{1} Triplet ( x , {x}_{+} , {x}_{-} ) + {κ}_{2} \{ max ( {\vert d ( f ( x ) , f ( {x}_{+} ) ) - \overline{d} ( f ( x ) , f ( {x}_{+} ) ) \vert}_{1} , {\vert d ( f ( x ) , f ( {x}_{+} ) ) - \underline{d} ( f ( x ) , f ( {x}_{+} ) ) \vert}_{1} ) + max ( {\vert d ( f ( x ) , f ( {x}_{-} ) ) - \overline{d} ( f ( x ) , f ( {x}_{-} ) ) \vert}_{1} , \text{} {\vert d ( f ( x ) , f ( {x}_{-} ) ) - \underline{d} ( f ( x ) , f ( {x}_{-} ) ) \vert}_{1} \text{} ) \} \qquad ( 27 )$$

In Expression (27), “Triplet(x, x+, x−)” is the term expressed in Expression (28) below.

$$[ Expression 28 ]$$

$$Triplet ( x , {x}_{+} , {x}_{-} ) = max ( d ( f ( x ) , f ( {x}_{+} ) ) - d ( f ( x ) , f ( {x}_{-} ) ) + m , 0 ) \qquad ( 28 )$$

This term is the same as the function described above in Expression (20) and is the term commonly used in learning models with triplet loss. This term serves to train the feature amount extractor f to decrease the distance between the anchor x and a positive sample x+belonging to the same class and increase the distance between the anchor x and a negative sample x− belonging to a different class, and is introduced in order to increase accuracy for normal data.

This term can be any term, not limited to “Triplet(x, x+, x−)”, as long as it is used to increase accuracy for normal data.

In Expression (27), “|d(f(x), f(x+))−⁻d(f(x), f(x+))|1” represents the absolute value of the difference between the distance between f(x) and f(x+) and the upper limit of the distance. Minimizing the term that includes this means training the feature amount extractor f so that the distance between f(x) and f(x+) and the upper limit of that distance are as close as possible.

“|d(f(x), f(x+))−_d(f(x), f(x+))|₁” represents the absolute value of the difference between the distance between f(x) and f(x+) and the lower limit of the distance. Minimizing the term that includes this means training the feature amount extractor f so that the distance between f(x) and f(x+) and the lower limit of that distance are as close as possible.

By “max(,)” is meant to take the larger of these terms.

The “|d(f(x), f(x−))−⁻d(f(x), f(x−)|₁” represents the absolute value of the difference between the distance between f(x) and f(x−) and the upper limit of the distance. Minimizing the term that includes this means training the feature amount extractor f so that the distance between f(x) and f(x−) and the upper limit of that distance are as close as possible.

The “|d(f(x), f(x−))−_d(f(x), f(x−)|₁” represents the absolute value of the difference between the distance between f(x) and f(x−) and the lower limit of the distance. Minimizing the term that includes this means training the feature amount extractor f so that the distance between f(x) and f(x−) and the lower limit of that distance are as close as possible.

By “max(,)” is meant to take the larger of these terms.

The term “x₂{ }” is the sum of two “max (,)” terms. Therefore, the term “x₂{ }” means training the feature amount extractor f to make the upper limit ⁻d(f(x), f(x+) and the lower limit _d(f(x), f(x+) of the distance d(f(x), f(x+)) as close to the distance d(f(x), f(x+)) as possible, and the upper limit ⁻d(f(x), f(x−) and the lower limit _d(f(x), f(x−) of the distance d(f(x), f(x−)) as close to the distance d(f(x), f(x−)) as possible.

Note that x₁ and x₂ are parameters for adjusting the size of the first and second terms.

The learning portion 308 trains the feature amount extractor f using all triplets (x, x+, x−) or some triplets (x, x+, x−) stored in the training data storage portion 302.

Next, the operation of the learning device 300 shall be described with reference to FIG. 10. FIG. 10 is a flowchart showing an example of a processing procedure in which the learning device 300 performs learning of a feature amount extractor.

The learning device 300 stores training data D={(x, x+, x−)ᵢ}(i=1 to N) in the training data storage portion 302. (x, x+, x−) is a triplet consisting of images x, x+, x−. For an anchor x, x+ is a positive sample, an image belonging to the same class as x. For an anchor x, x− is a negative sample, an image belonging to a different class than x.

First, the triplet acquisition portion 304 of the learning device 300 acquires one triplet (x, x+, x−) from the training data storage portion 302 (Step S301).

Next, the upper limit/lower limit calculation portion 306 calculates the upper and lower limits of d(f(x), f(x+)) satisfying Expression (21) for the anchor x and positive sample x+using Expressions (22) and (23), respectively. The upper limit/lower limit calculation portion 306 also calculates the upper and lower limits of d(f(x), f(x−)) satisfying Expression (24) for the anchor x and negative sample x− using Expressions (25) and (26), respectively (Step S302).

Next, the learning portion 308 receives the triplet (x, x+, x−) and the calculated upper and lower limits and performs learning of the feature amount extractor f so that the loss function shown in Expression (27) is minimized (Step S303).

Next, the learning device 300 determines whether the predetermined end condition is met (Step S304). The end condition here is not limited to a specific one. For example, the end condition that the decreasing range of the loss function in Expression (27) is smaller than a given threshold may be used. The end condition that the number of times the loop from S301 to S303 has been executed reaches a predetermined number may also be used. The end condition that learning has been completed for the triplets stored in the training data storage portion 302 that satisfy a predetermined conditions may also be used.

If the end condition is not satisfied, the learning device 300 moves the control to Step S301, and if the end condition is satisfied, it ends the process in FIG. 10.

As explained above, the training data storage portion 302 stores training data that are triplets. The triplet acquisition portion 304 acquires the triplet. The upper limit/lower limit calculation portion 306 calculates the upper and lower limits of the distance d(f(x), f(x+)) for the anchor x and the positive sample x+, and the upper and lower limits of the distance d(f(x), f(x−)) for the anchor x and the negative sample x−. The learning portion 308 performs learning of the feature amount extractor f to minimize the loss function that includes the upper and lower limits of the distance between the anchor x and the positive sample x+ as well as the upper and lower limits of the distance between the anchor x and the negative sample x−.

Thereby, the learning device 300 can perform learning of the feature amount extractor f such that the upper limit and lower limit of a distance, obtained in a case where the feature extractor is used, in a feature space between images become as close as possible to the distance. In particular, the learning device 300 can perform learning of the feature amount extractor f such that the upper limit and lower limit of a distance in the feature space between images that are the anchor x and the positive sample x+included in a triplet of training data become as close as possible to the distance, and the upper limit and lower limit of the distance in the feature space between images that are the anchor x and negative sample x− become as close as possible to the distance.

This also enables learning of the feature amount extractor f so that the distance d(f(q+δ), f(c)) or d(f(q), f(c+q)) in the feature space in a case where noise δ is added to the image is close to the distance d(f(q), f(c)) in the feature space in a case where no noise is added.

Therefore, (α, ß)-robustness verification and α-robustness verification can be performed with high accuracy for content-based image retrieval.

### Fourth Example Embodiment

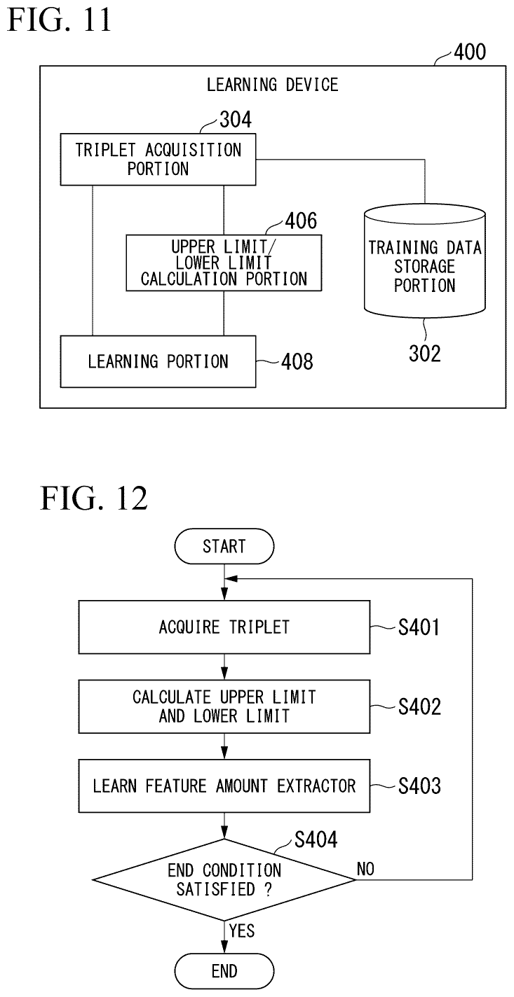

FIG. 11 is a schematic block diagram showing an example of the functional configuration of a learning device 400 according to the fourth example embodiment. The learning device 400 is provided with a training data storage portion 302, a triplet acquisition portion 304, an upper limit/lower limit calculation portion 406, and a learning portion 408. The training data storage portion 302 and triplet acquisition portion 304 of the learning device 400 have the same functions as the training data storage portion 302 and triplet acquisition portion 304 of the learning device 300, so the same reference numerals are used and explanations thereof are omitted.

The upper limit/lower limit calculation portion 406 receives the triplet (x, x+, x−) from the triplet acquisition portion 304. The upper limit/lower limit calculation portion 406 first calculates only the upper limit of d(f(x), f(x+)) that satisfies Expression (21) for anchor x and positive sample x+, using Expression (22). The upper limit/lower limit calculation portion 406 calculates only the lower limit of d(f(x), f(x−)) satisfying Expression (24) for the anchor x and negative sample x− using Expression (26).

The upper limit/lower limit calculation portion 406 outputs the calculated upper and lower limits to the learning portion 408.

The learning portion 408 performs learning of the feature amount extractor f using triplet loss. Specifically, the learning portion 408 receives the triplet (x, x+, x−) and the calculated upper and lower limits and performs learning of the feature amount extractor f so that the loss function shown in Expression (29) is minimized.

$$[ Expression 29 ]$$

$${κ}_{1} Triplet ( x , {x}_{+} , {x}_{-} ) + {κ}_{2} CertTriplet ( x , {x}_{+} , {x}_{-} ) \qquad ( 29 )$$

In Expression (29), “Triplet(x, x+, x−)” is the same as the term expressed in Expression (28) above. This term can be any term, not limited to “Triplet(x, x+, x−)”, as long as it is used to increase accuracy for normal data.

In Expression (29), “CertTriplet(x, x+, x−)” is thus expressed by the following Expression (30).

$$[ Expression 30 ]$$

$$CertTriplet ( x , {x}_{+} , {x}_{-} ) = max ( \overline{d} ( f ( x ) , f ( {x}_{+} ) ) - \underline{d} ( f ( x ) , f ( {x}_{-} ) ) + m , 0 ) \qquad ( 30 )$$

This term serves to perform learning of the feature amount extractor f so as to make the upper limit of the distance between the anchor x and a positive sample x+belonging to the same class closer and the lower limit of the distance between the anchor x and a negative sample x− belonging to a different class farther. The “m” is a positive real constant that represents the hyperparameter for the margin, meaning that learning of the feature amount extractor f is performed so that the upper limit ⁻d(f(x), f(x+)) and the lower limit _d(f(x), f(x−)) are m apart.

Note that x₁ and x₂ are parameters for adjusting the size of the first and second terms.

The learning portion 408 performs learning of the feature amount extractor f using all triplets (x, x+, x−) or some triplets (x, x+, x−) stored in the training data storage portion 302.

Next, the operation of the learning device 400 shall be described with reference to FIG. 12. FIG. 12 is a flowchart showing an example of a processing procedure in which the learning device 400 performs learning of a feature amount extractor.

The learning device 400 stores training data D={(x, x+, x−)ᵢ}(i=1 to N) in the training data storage portion 302. (x, x+, x−) is a triplet consisting of images x, x+, x−. For an anchor x, x+ is a positive sample, an image belonging to the same class as x. For an anchor x, x− is a negative sample, an image belonging to a different class than x.

First, the triplet acquisition portion 304 of the learning device 400 acquires one triplet (x, x+, x−) from the training data storage portion 302 (Step S401).

Next, the upper limit/lower limit calculation portion 406 calculates only the upper limit of d(f(x), f(x+)) that satisfies Expression (21) for anchor x and positive sample x+, using Expression (22). The upper limit/lower limit calculation portion 406 calculates only the lower limit of d(f(x), f(x−)) satisfying Expression (24) for the anchor x and negative sample x− using Expression (26) (Step S402).

Next, the learning portion 408 receives the triplet (x, x+, x−) and the calculated upper and lower limits and performs learning of the feature amount extractor f so that the loss function shown in Expression (29) is minimized (Step S403).

Next, the learning device 400 determines whether the predetermined end condition is met (Step S404). The end condition here is not limited to a specific one. Conditions similar to the end condition described for the learning device 400 are possible.

If the end condition is not satisfied, the learning device 400 moves the control to Step S401, and if the end condition is satisfied, it ends the process in FIG. 12.

As explained above, the training data storage portion 302 stores training data that are triplets. The triplet acquisition portion 304 acquires the triplet. The upper limit/lower limit calculation portion 406 calculates only the upper limit of the distance d(f(x), f(x+)) for the anchor x and the positive sample x+, and only the lower limit of the distance d(f(x), f(x−)) for the anchor x and the negative sample x−. The learning portion 408 performs learning of the feature amount extractor f to minimize the loss function that includes the upper limit of the distance between the anchor x and the positive sample x+ as well as the lower limit of the distance between the anchor x and the negative sample x−.

Thereby, the learning device 400, with the term “CertTriplet(x, x+, x−)” in Expression (29), can perform learning of the feature amount extractor f so as to make the upper limit of the distance between the anchor x and a positive sample x+belonging to the same class closer and the lower limit of the distance between the anchor x and a negative sample x− belonging to a different class father. Also, with the term “Triplet(x, x+, x−)” in Expression (29) enables learning of the feature amount extractor f so as to move closer to the distance between the anchor x and a positive sample x+belonging to the same class and move away from the distance between the anchor x and a negative sample x− belonging to a different class. Considering the above, it is thought that Expression (29) can enable learning of the feature amount extractor f so that the upper limit of the distance in the feature space between images that are the anchor x and the positive sample x+ is as close as possible to the distance, and the lower limit of the distance in the feature space between images that are the anchor x and negative sample x− is as close as possible to the distance.

This also enables learning of the feature amount extractor f so that the distance d(f(q+δ), f(c)) or d(f(q), f(c+q)) in the feature space in a case where noise δ is added to the image is close to the distance d(f(q), f(c)) in the feature space in a case where no noise is added.

Therefore, (α, ß)-robustness verification and α-robustness verification can be performed with high accuracy for content-based image retrieval.

### Fifth Example Embodiment

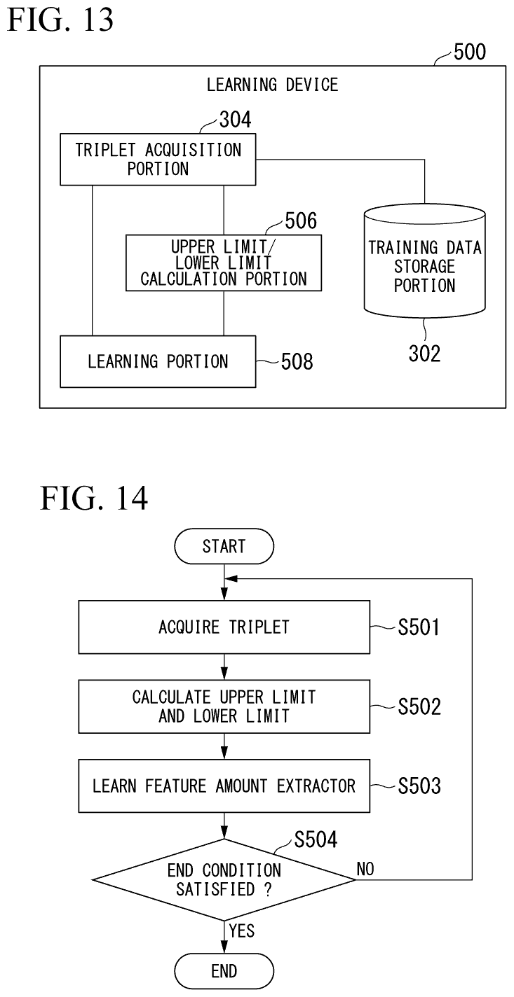

FIG. 13 is a schematic block diagram showing an example of the functional configuration of a learning device 500 according to the fifth example embodiment. The learning device 500 is provided with a training data storage portion 302, a triplet acquisition portion 304, an upper limit/lower limit calculation portion 506, and a learning portion 508. The training data storage portion 302 and triplet acquisition portion 304 of the learning device 500 have the same functions as the training data storage portion 302 and triplet acquisition portion 304 of the learning device 300, so the same reference numerals are used and explanations thereof are omitted.

The upper limit/lower limit calculation portion 506 receives the triplet (x, x+, x−) from the triplet acquisition portion 304. The upper limit/lower limit calculation portion 506 calculates the upper limit of d(f(x), f(x)) that satisfies Expression (31) for anchor x, using Expression (32).

$$[ Expression 31 ]$$

$$d ( f ( x ) , f ( x ) ) \leq \overline{d} ( f ( x ) , f ( x ) ) \qquad ( 31 )$$

$$[ Expression 32 ]$$

$$\overline{d} ( f ( x ) , f ( x ) ) = {( {\sum }_{i} {max ( {\vert {\overline{f} ( x )}_{i} - {f ( x )}_{i} \vert}_{1} , {\vert {f ( x )}_{i} - {\underline{f} ( x )}_{i} \vert}_{1} )}^{2} )}^{\frac{1}{2}} \qquad ( 32 )$$

The upper limit/lower limit calculation portion 506 performs calculations using Interval Bound Propagation (IBP), a known technique described in the aforementioned reference. The upper limit/lower limit calculation portion 506 calculates the upper limit ⁻f(x)ᵢ and lower limit _f(x)ᵢ of f(x)ᵢ using IBP, where i represents the i-th element of the n-dimensional vector. Using these upper and lower limits, the upper limit ⁻d(f(x), f(x)) of d(f(x), f(x)) is calculated using Expression (32).

In Expression (32), “|⁻f(x)ᵢ−f(x)ᵢ|₁” represents the absolute value of the difference between the upper limit of the i-th element of the feature amount of image x and the i-th element of the feature amount of image x+. “|f(x)ᵢ−_f(x)ᵢ|₁” represents the absolute value of the difference between the i-th element of the feature amount of image x and the lower limit of the i-th element of the feature amount of image x. The right-hand side of Expression (32) represents the square of the larger of these values squared and summed over all elements i in dimension n. This value is the upper limit ⁻d(f(x), f(x)) of d(f(x), f(x)).

The upper limit/lower limit calculation portion 506 outputs the calculated upper limit to the learning portion 508.

The learning portion 508 performs learning of the feature amount extractor f using triplet loss. Specifically, the learning portion 508 receives the triplet (x, x+, x−) and the calculated upper limit and performs learning of the feature amount extractor f so that the loss function shown in Expression (33) is minimized.

### Expression 33

$$[ Expression 33 ]$$

$${κ}_{1} Triplet ( x , {x}_{+} , {x}_{-} ) + {κ}_{2} \overline{d} ( f ( x ) , f ( x ) ) \qquad ( 33 )$$

In Expression (33), “Triplet(x, x+, x−)” is the same as the term expressed in Expression (28) above. This term can be any term, not limited to “Triplet(x, x+, x−)”, as long as it is used to increase accuracy for normal data.

In Expression (33), “⁻d(f(x), f(x))” is the term expressed in Expression (32) above. This term serves to perform learning of the feature value extractor f so that the upper limit of the distance of the anchor image x itself is kept as small as possible.

Note that x₁ and x₂ are parameters for adjusting the size of the first and second terms.

The learning portion 508 performs learning of the feature amount extractor f using all triplets (x, x+, x−) or some triplets (x, x+, x−) stored in the training data storage portion 302.

Next, the operation of the learning device 500 shall be described with reference to FIG. 14. FIG. 14 is a flowchart showing an example of a processing procedure in which the learning device 500 performs learning of a feature amount extractor.

The learning device 500 stores training data D={(x, x+, x−)ᵢ}(i=1 to N) in the training data storage portion 302. (x, x+, x−) is a triplet consisting of images x, x+, x−. For an anchor x, x+ is a positive sample, an image belonging to the same class as x. For an anchor x, x− is a negative sample, an image belonging to a different class than x.

First, the triplet acquisition portion 304 of the learning device 500 acquires one triplet (x, x+, x−) from the training data storage portion 302 (Step S502).

Next, the upper limit/lower limit calculation portion 506 calculates the upper limit ⁻d(f(x), f(x)) of d(f(x), f(x)) that satisfies Expression (31) for anchor x, using Expression (32) (Step S402).

Next, the learning portion 508 receives the triplet (x, x+, x−) and the calculated upper limit and performs learning of the feature amount extractor f so that the loss function shown in Expression (33) is minimized (Step S503).

Next, the learning device 500 determines whether the predetermined end condition is met (Step S504). The end condition here is not limited to a specific one. Conditions similar to the end condition described for the learning device 300 are possible.

If the end condition is not satisfied, the learning device 500 moves the control to Step S501, and if the end condition is satisfied, it ends the process in FIG. 14.

As explained above, the training data storage portion 302 stores training data that are triplets. The triplet acquisition portion 304 acquires the triplet. The upper limit/lower limit calculation portion 506 calculates the upper limit of distance d(f(x), f(x)) for image x. The learning portion 508 performs learning of the feature amount extractor f to minimize the loss function that contains the upper limit of the distance of the image x itself.

This allows the learning device 500 to perform learning of the feature amount extractor f so that the upper limit of the distance in the feature space of the image x itself is as small as possible. Therefore, the learning device 500 can perform learning of the feature amount extractor f so that the upper limit of the distance in the feature space between different images is also as small as possible.

This also enables learning of the feature amount extractor f so that the distance d(f(q+δ), f(c)) or d(f(q), f(c+q)) in the feature space in a case where noise δ is added to the image is close to the distance d(f(q), f(c)) in the feature space in a case where no noise is added.

Therefore, (α, ß)-robustness verification and α-robustness verification can be performed with high accuracy for content-based image retrieval.

### Sixth Example Embodiment

In the learning of the third to fifth example embodiments, in the situation where the input image q and candidate image group C are not possessed for content-based image retrieval, the training data D={(x, x+, x−)ᵢ}(i=1 to N), which does not overlap with the input image q and candidate image group C for content-based image retrieval, is used to train the feature amount extractor f. This was intended to increase the accuracy of robustness verification against query attacks and candidate attacks.

In contrast, the learning in the sixth example embodiment aims to improve the accuracy of robustness verification in a case where using the candidate image group C for the input image q, which is a query that may come, given a database that stores the candidate image group C, after the feature amount extractor has been learned by learning of the third through fifth example embodiments.

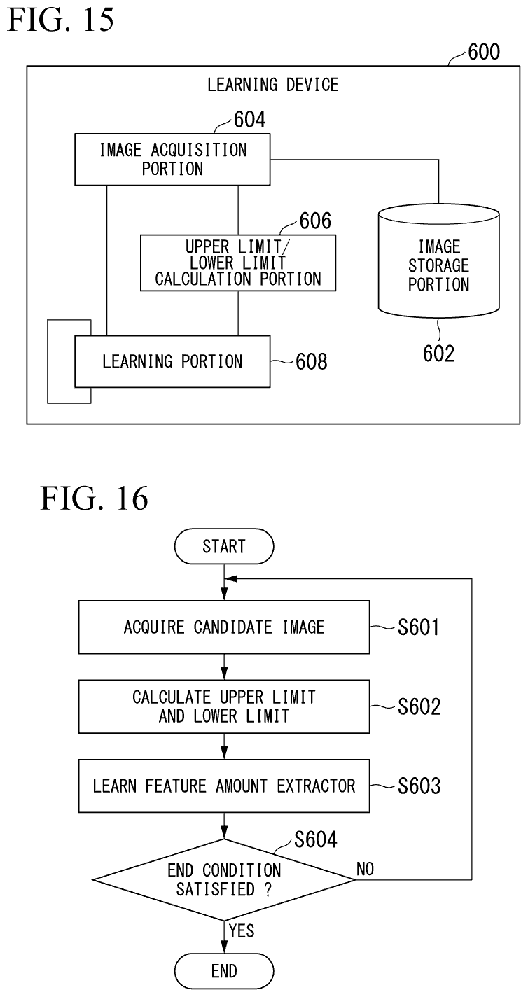

FIG. 15 is a schematic block diagram showing an example of the functional configuration of a learning device 600 according to the sixth example embodiment. The learning device 600 is provided with an image storage portion 602, an image acquisition portion 604, an upper limit/lower limit calculation portion 606, and a learning portion 608. The learning device 600 according to the sixth example embodiment performs learning of the feature amount extractor f using the candidate image group C={cᵢ∈χ}(i=1 to N).

The image storage portion 602 stores the candidate image group C={cᵢ∈χ}(i=1 to N). The candidate image group C is a group of images to be searched by the content-based image retrieval device 900.

The image acquisition portion 604 acquires each candidate image c from the image storage portion 602 and outputs it to the upper limit/lower limit calculation portion 606 and the learning portion 608.

The upper limit/lower limit calculation portion 606 receives the candidate image c from the image acquisition portion 604. The upper limit/lower limit calculation portion 606 calculates the upper and lower limits of the distance d(f(c₁), f(c₂)) satisfying Expression (34) for the two candidate images c₁, c₂ using Expressions (35) and (36), respectively.

$$[ Expression 34 ]$$

$$\underline{d} ( f ( {c}_{1} ) , f ( {c}_{2} ) ) \leq d ( f ( {c}_{1} ) , f ( {c}_{2} ) ) \leq \overline{d} ( f ( {c}_{1} ) , f ( {c}_{2} ) ) \qquad ( 34 )$$

$$[ Expression 35 ]$$

$$\overline{d} ( f ( {c}_{1} ) , f ( {c}_{2} ) ) = {( {\sum }_{i} {max ( {\vert {\overline{f} ( {c}_{1} )}_{i} - {f ( {c}_{2} )}_{i} \vert}_{1} , {\vert {f ( {c}_{2} )}_{i} - {\underline{f} ( {c}_{1} )}_{i} \vert}_{1} )}^{2} )}^{\frac{1}{2}} \qquad ( 35 )$$

$$[ Expression 36 ]$$

$$\underline{d} ( f ( {c}_{1} ) , f ( {c}_{2} ) ) = {( {\sum }_{i} {min ( 0 , {\overline{f} ( {c}_{1} )}_{i} - {f ( {c}_{2} )}_{i} , {f ( {c}_{2} )}_{i} - {\underline{f} ( {c}_{1} )}_{i} )}^{2} )}^{\frac{1}{2}} \qquad ( 36 )$$

The upper limit/lower limit calculation portion 606 performs calculations using Interval Bound Propagation (IBP), a known technique described in the aforementioned reference. The upper limit/lower limit calculation portion 606 uses IBP to calculate the upper limit ⁻f(c)ᵢ and the lower limit _f(c)ᵢ, of f(c)ᵢ, where i represents the i-th element of the n-dimensional vector. Using these upper and lower limits, the upper limit ⁻d(f(cᵢ), f(c₂)) and the lower limit _d(f(c₁), f(c₂)) of d(f(c₁), f(c₂)) are calculated using Expressions (35) and (36), respectively.

In Expression (35), “|⁻f(c₁)ᵢ−f(c₂)ᵢ|₁” represents the absolute value of the difference between the upper limit of the i-th element of the feature amount of image c₁ and the i-th element of the feature amount of image c₂. “|f(c₂)ᵢ−_f(c₁)|₁” represents the absolute value of the difference between the i-th element of the feature amount of image x+ and the lower limit of the i-th element of the feature amount of image x. The right-hand side of Expression (35) represents the square of the larger of these values squared and summed over all elements i in dimension n. This value is the upper limit ⁻d(f(c₁), f(c₂)) of d(f(c₁), f(c₂)).

In Expression (36), “⁻f(c₁)ᵢ-f(c₂)ᵢ” represents the difference between the upper limit of the i-th element of the feature amount of image c₁ and the i-th element of the feature amount of image c₂. “f(c₂)−_f(c₁)ᵢ” represents the difference between the i-th element of the feature amount of image c₂ and the lower limit of the i-th element of the feature amount of image c₁. The right-hand side of Expression (36) represents the square of the smaller of these values and 0 squared and summed over all elements i in dimension n. This value is the lower limit _d(f(cᵢ), f(c₂)) of d(f(c₁), f(c₂)).

The upper limit/lower limit calculation portion 606 outputs the calculated upper and lower limits to the learning portion 608.

The learning portion 608 performs learning of the feature amount extractor f using the loss function. Specifically, the learning portion 608 receives the candidate images c₁, c₂, the calculated upper and lower limits, and the feature amount extractor f₀ that was learned immediately before, and performs learning of the feature amount extractor f so that the loss function shown in Expression (37) is minimized.

$$[ Expression 37 ]$$

$${κ}_{1} d ( {f}_{0} ( {c}_{1} ) , f ( {c}_{1} ) ) + {κ}_{2} \{ max ( {\vert d ( f ( {c}_{1} ) , f ( {c}_{2} ) ) - \overline{d} ( f ( {c}_{1} ) , f ( {c}_{2} ) ) \vert}_{1} , {\vert d ( f ( {c}_{1} ) , f ( {c}_{2} ) ) - \underline{d} ( f ( {c}_{1} ) , f ( {c}_{2} ) ) \vert}_{1} ) \} \qquad ( 37 )$$

In Expression (37), “|d(f(c₁), f(c₂))−⁻d(f(c₁), f(c₂))|₁” represents the absolute value of the difference between the distance between f(c₁) and f(c₂) and the upper limit of the distance. Minimizing the term that includes this means performing learning of the feature amount extractor f so that the distance between f(c₁) and f(c₂) and the upper limit of that distance are as close as possible.

“|d(f(c₁), f(c₂))−_d(f(c₁), f(c₂))|₁” represents the absolute value of the difference between the distance between f(c₁) and f(c₂) and the lower limit of the distance. Minimizing the term that includes this means performing learning of the feature amount extractor f so that the distance between f(c₁) and f(c₂) and the lower limit of that distance are as close as possible.

By “max(,)” is meant to take the larger of these terms.

On the other hand, in “d(f₀(c₁), f(c₁))” of Expression (37), “f₀( )” represents the feature amount extractor before the update (learned just before). The “f( )” represents the feature amount extractor to be learned this time. Minimizing by including “d(f₀(cᵢ), f(c₁))” means that the features of image c₁ should not change between f₀ before and f after the update. This term was added to maintain the accuracy of f for normal data, because if only the second term is constrained, the accuracy of f for normal data will deteriorate.

Learning f ( ) using f₀( ) is called additional learning (fine-tuning).

x₁ and x₂ are parameters for adjusting the size of the first and second terms.

The learning portion 608 performs learning of the feature amount extractor f using all or some of the candidate images stored in the image storage portion 602.

Next, the operation of the learning device 600 shall be described with reference to FIG. 16. FIG. 16 is a flowchart showing an example of a processing procedure in which the learning device 600 performs learning of a feature amount extractor.

The learning device 600 stores the candidate image group C={cᵢ∈χ}(i=1 to N) in the image storage portion 602.

First, the image acquisition portion 604 acquires each candidate image c from the image storage portion 602 (Step S601).

Next, the upper limit/lower limit calculation portion 606 calculates the upper limit ⁻d(f(c₁), f(c₂)) and lower limit _d(f(c₁), f(c₂)) of d(f(c₁), f(c₂)) satisfying Expression (34) for the two candidate images c₁, c₂, using Expressions (35) and (36), respectively (Step S602).

Next, the learning portion 608 receives the candidate images c₁, c₂, the calculated upper and lower limits, and the feature amount extractor f₀ that was learned immediately before, and performs learning of the feature amount extractor f so that the loss function shown in Expression (37) is minimized (Step S603).

Next, the learning device 600 determines whether the predetermined end condition is met (Step S604). The end condition here is not limited to a specific one. For example, the end condition that the decreasing range of the loss function in Expression (37) is smaller than a predetermined threshold may be used. The end condition that the number of times the loop from S601 to S603 has been executed reaches a predetermined number may also be used. The end condition that learning has been completed for the candidate images that satisfy the predetermined condition among the candidate images c stored in the image storage portion 602 may also be used.

If the end condition is not satisfied, the learning device 600 moves the control to Step S601, and if the end condition is satisfied, it ends the process in FIG. 15.

As explained above, the image storage portion 602 stores the candidate image group C. The image acquisition portion 604 acquires candidate images. The upper limit/lower limit calculation portion 606 calculates the upper limit ⁻d(f(c₁), f(c₂)) and lower limit _d(f(c₁), f(c₂)) of d(f(c₁), f(c₂)) satisfying Expression (34) for the two candidate images c₁, c₂. The learning portion 608 performs learning of the feature amount extractor f so as to minimize the loss function, which includes the upper and lower limits of the distance between the two candidate images c₁ and c₂ and the distance between the feature amounts by the feature amount extractor f before and after the update of the candidate image c₁.

Thereby, the learning device 600 can perform learning of the feature amount extractor f such that the upper limit and the lower limit of the distance, obtained in a case where the feature extractor f is used, in a feature space between candidate images become as close as possible to the distance. The learning device 600 can also maintain the accuracy of feature amounts for candidate images before and after updating the feature amount extractor.

This also enables learning of the feature amount extractor f so that the distance d(f(q+δ), f(c)) or d(f(q), f(c+q)) in the feature space in a case where noise δ is added to the image is close to the distance d(f(q), f(c)) in the feature space in a case where no noise is added.

Therefore, (α, ß)-robustness verification and α-robustness verification can be performed with high accuracy for content-based image retrieval.

### Seventh Example Embodiment

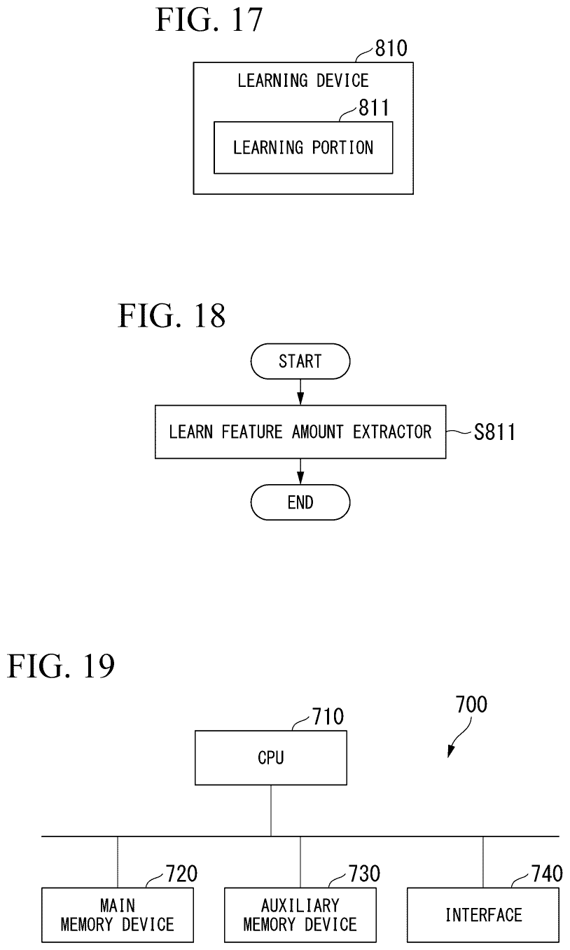

FIG. 17 is a diagram showing an example of the configuration of a learning device according to the seventh example embodiment. In the configuration shown in FIG. 17, a learning device 810 is provided with a learning portion 811.

In such a configuration, the learning portion 811 performs learning of the feature amount extractor such that the upper limit and the lower limit of the distance, obtained in a case where the feature extractor f is used, in a feature space between images become close to the distance.

The learning portion 811 is an example of a learning means.

This allows the learning device 810 to perform learning of the feature amount extractor f such that the upper limit and the lower limit of the distance in the feature space between images in a case where using the feature amount extractor are as close as possible to the distance. In other words, the learning device 810 can perform learning of the feature amount extractor f so that the distance d(f(q+δ), f(c)) or d(f(q), f(c+q)) in the feature space in a case where noise δ is added to the image is close to the distance d(f(q), f(c)) in the feature space in a case where no noise is added. Thus, robustness can be verified with high accuracy for content-based image retrieval.

### Eighth Example Embodiment

FIG. 18 is a diagram showing an example of the processing steps in the learning method according to the eighth example embodiment. The learning method shown in FIG. 18 includes performing learning of a feature amount extractor (Step S811).

In performing learning of the feature amount extractor (Step S811), learning of the feature amount extractor is performed so that the upper and lower limits of the distance, obtained in a case where the feature extractor f is used, in the feature space between images, become close to the distance.

According to the learning method shown in FIG. 18, learning of the feature amount extractor can be performed such that the upper limit and lower limit of a distance, obtained in a case where the feature amount extractor is used, in a feature space between images become as close as possible to the distance. In other words, according to the learning method shown in FIG. 18, learning of the feature amount extractor can be performed so that the distance d(f(q+δ), f(c)) or d(f(q), f(c+q)) in the feature space in a case where noise δ is added to the image is close to the distance d(f(q), f(c)) in the feature space in a case where no noise is added. Thus, robustness can be verified with high accuracy for content-based image retrieval.

FIG. 19 is a schematic block diagram showing the configuration of a computer according to at least one example embodiment.

In the configuration shown in FIG. 19, a computer 700 is provided with a CPU (Central Processing Unit) 710, a main memory device 720, an auxiliary memory device 730, and an interface 740.

Any one or more of the robustness verification devices 100, 200, and the learning devices 300, 400, 500, 600 described above may be implemented in the computer 700.

In that case, the operations of each of the above-mentioned processing portions are stored in the auxiliary memory device 730 in the form of a program. The CPU 710 reads the program from the auxiliary memory device 730, expands it in the main memory device 720, and executes the above processing according to the program. The CPU 710 also reserves a memory area in the main memory device 720 corresponding to each of the above-mentioned storage portions according to the program. Communication between each device and other devices is performed by the interface 740, which has a communication function and communicates according to the control of the CPU 710.

In a case where the robustness verification device 100 is implemented in the computer 700, the operations of the similar image identification portion 102, the comparison target image calculation portion 104, the upper limit/lower limit calculation portion 106, and the rank verification portion 108 are stored in auxiliary memory device 730 in program form. The CPU 710 reads the program from the auxiliary memory device 730, expands it in the main memory device 720, and executes the above processing according to the program.

The output of the (α, ß)-robustness verification of the robustness verification device 100 is executed by the interface 740, which has output functions such as communication or display functions and performs output processing according to the control of the CPU 710.

In a case where the robustness verification device 200 is implemented in the computer 700, the operations of the similar image identification portion 202, upper limit/lower limit calculation portion 206, and the rank verification portion 208 are stored in the auxiliary memory device 730 in the form of programs. The CPU 710 reads the program from the auxiliary memory device 730, expands it in the main memory device 720, and executes the above processing according to the program.

The output of the α-robustness verification of the robustness verification device 200 is executed by the interface 740, which has output functions such as communication or display functions and performs output processing according to the control of the CPU 710.

In a case where the learning device 300 is implemented in the computer 700, the operations of the triplet acquisition portion 304, the upper limit/lower limit calculation portion 306, and the learning portion 308 are stored in the auxiliary memory device 730 in the form of programs. The training data in the training data storage portion 302 is stored in the auxiliary memory device 730. The CPU 710 reads the program from the auxiliary memory device 730, expands it in the main memory device 720, and executes the above processing according to the program.

The learning portion 308 of the learning device 300 may output the feature amount extractor f or parameters thereof, which is performed by the interface 740 having output functions such as communication or display functions and performing output processing according to the control of the CPU 710.

In a case where the learning device 400 is implemented in the computer 700, the operations of the triplet acquisition portion 304, the upper limit/lower limit calculation portion 406, and the learning portion 408 are stored in the auxiliary memory device 730 in the form of programs. The training data in the training data storage portion 302 is stored in the auxiliary memory device 730. The CPU 710 reads the program from the auxiliary memory device 730, expands it in the main memory device 720, and executes the above processing according to the program.

The learning portion 408 of the learning device 400 may output the feature amount extractor f or parameters thereof, which is performed by the interface 740 having output functions such as communication or display functions and performing output processing according to the control of the CPU 710.

In a case where the learning device 500 is implemented in the computer 700, the operations of the triplet acquisition portion 304, the upper limit/lower limit calculation portion 506, and the learning portion 508 are stored in the auxiliary memory device 730 in the form of programs. The training data in the training data storage portion 302 is stored in the auxiliary memory device 730. The CPU 710 reads the program from the auxiliary memory device 730, expands it in the main memory device 720, and executes the above processing according to the program.

The learning portion 508 of the learning device 500 may output the feature amount extractor f or parameters thereof, which is performed by the interface 740 having output functions such as communication or display functions and performing output processing according to the control of the CPU 710.

In a case where the learning device 600 is implemented in the computer 700, the operations of the image acquisition portion 604, the upper limit/lower limit calculation portion 606, and the learning portion 608 are stored in the auxiliary memory device 730 in the form of programs. The candidate images in the image storage portion 302 are stored in the auxiliary memory device 730. The CPU 710 reads the program from the auxiliary memory device 730, expands it in the main memory device 720, and executes the above processing according to the program.

The learning portion 608 of the learning device 600 may output the feature amount extractor f or parameters thereof, which is performed by the interface 740 having output functions such as communication or display functions and performing output processing according to the control of the CPU 710.

While preferred example embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### INDUSTRIAL APPLICABILITY

Example embodiments of the present invention may be applied to a robustness verification device, a robustness verification method, a learning device, a learning method, a programs, and a recording medium.

### DESCRIPTION OF REFERENCE SIGNS

100, 200 Robustness verification device
102, 202 Similar image identification portion
104 Comparison target image calculation portion
106, 206 Upper limit/lower limit calculation portion
108, 208 Rank verification portion
110 (210) Rank calculation portion
112, 212 Rank counting portion
300, 400, 500, 600 Learning device
302 Training data storage portion
304 Triplet acquisition portion
306, 406, 506, 606 Upper limit/lower limit calculation portion
308, 408, 508, 608 Learning portion
602 Image storage portion
604 Image acquisition portion
900 Content-based image retrieval device
902 Image storage portion
904 Feature amount extraction portion
906 Rank calculation portion

1. A learning device comprising:
at least one memory configured to store instructions; and
at least one processor configured to execute the instructions to:
cause a feature amount extractor to be trained such that the upper limit and the lower limit of a distance, obtained in a case where the feature amount extractor is used, in a feature space between images become close to the distance.

2. The learning device according to claim 1,
wherein the at least one processor is configured to execute the instructions to cause the feature amount extractor to be trained by minimizing a loss function.

3. The learning device according to claim 2,
wherein the at least one processor is configured to execute the instructions to cause the feature amount extractor to be trained by minimizing the loss function that includes a term representing the difference between the distance and the upper limit of the distance and a term representing the difference between the distance and the lower limit of the distance in the feature space between the images.

4. The learning device according to claim 2,
wherein the at least one processor is configured to execute the instructions to cause the feature amount extractor to be trained by minimizing the loss function that includes a term representing an upper limit of the distance in the feature space between the same images.

5. The learning device according to claim 2,
wherein the at least one processor is configured to execute the instructions to cause the feature amount extractor to be trained by using triplet loss to minimize the loss function including a term representing the difference between the distance in the feature space and the upper limit of the distance for an anchor image and a positive sample image, as well as a term representing the difference between the distance and the lower limit of the distance for the anchor image and a negative sample image.

6. The learning device according to claim 2,
wherein the at least one processor is configured to execute the instructions to cause the feature amount extractor to be trained by using triplet loss to minimize the loss function so as to make the upper limit of the distance between the anchor image and the positive sample image closer and the lower limit of the distance between the anchor image and the negative sample image farther.

7. The learning device according to claim 3,
wherein the image is an image included in a candidate image group used for content-based image retrieval.

8. The learning device according to claim 7,
wherein the at least one processor is configured to execute the instructions to cause the feature amount extractor to be trained by minimizing the loss function that includes a term representing the distance between the feature amount of an image using a feature amount extractor before updating and the feature amount of the image using the feature amount extractor to be updated.

9. The learning device according to claim 1,
wherein the upper limit and lower limit of the distance in the feature space between images x₁ and x₂ are calculated by the following Expressions, respectively,
$$\overline{d} ( f ( {x}_{1} ) , f ( {x}_{2} ) ) = {( {\sum }_{i} {max ( {\vert {\overline{f} ( {x}_{1} )}_{i} - {f ( {x}_{2} )}_{i} \vert}_{1} , {\vert {f ( {x}_{2} )}_{i} - {\underline{f} ( {x}_{1} )}_{i} \vert}_{1} )}^{2} )}^{\frac{1}{2}} \qquad [ Expression 1 ]$$
$$\underline{d} ( f ( {x}_{1} ) , f ( {x}_{2} ) ) = {( {\sum }_{i} {min ( 0 , {\overline{f} ( {x}_{1} )}_{i} - {f ( {x}_{2} )}_{i} , {f ( {x}_{2} )}_{i} - {\underline{f} ( {x}_{1} )}_{i} )}^{2} )}^{\frac{1}{2}} \qquad [ Expression 2 ]$$
where i represents the i-th element in a case where the image is mapped by the feature amount extractor to an n-dimensional vector in the feature space.

10. A learning method comprising:
causing a feature amount extractor to be trained such that the upper limit and the lower limit of a distance, obtained in a case where the feature amount extractor is used, in a feature space between images become close to the distance.

11. A non-transitory recording medium that records a program for causing a computer to execute:
causing a feature amount extractor to be trained such that the upper limit and the lower limit of a distance, obtained in a case where the feature amount extractor is used, in a feature space between images become close to the distance.
